(19) United States
(12) Patent Application Publication
(10) Pub. No.: US 2011/0242038 A1
(43) Pub. Date: Oct. 6, 2011

(54) INPUT DEVICE, INPUT METHOD, AND COMPUTER PROGRAM FOR ACCEPTING TOUCHING OPERATION INFORMATION

(75) Inventors: Jun KAKUTA, Kawasaki (JP); Ryuichi Matsukura, Kawasaki (JP); Ai Yano, Kawasaki (JP)

(73) Assignee: FUJITSU LIMITED, Kawasaki (JP)

(21) Appl. No.: 13/160,601

(22) Filed: Jun. 15, 2011

Related U.S. Application Data
(63) Continuation of application No. PCT/JP2008/073509, filed on Dec. 25, 2008.

(51) Int. Cl. G06F 3/041

(52) U.S. Cl. 345/173

(57) ABSTRACT

An input method for accepting input information by a touching operation performed on a touch target, includes: acquiring information about the touched region in which the touching operation is performed on the touch target; determining a display mode of an operation target indicator displayed with the touching operation according to the information about the touched region; outputting a display instruction for displaying the operation target indicator in the determined display mode; moving the displayed operation target indicator according to the movement of the touched region; and accepting the input information corresponding to a display position of the operation target indicator when the touching operation is finished.

### CROSS-REFERENCE TO RELATED APPLICATION

This application is a continuation of an international application PCT/JP2008/073509, which was filed on Dec. 25, 2008, the entire contents of which are incorporated herein by reference.

### FIELD

The present invention relates to a computer program, an input device, and an input method for accepting input information by a touching operation.

### BACKGROUND

Recently, various electric equipments use an input/output interface with a touch panel. Since a touch panel is operated by a user directly touching a menu, a button, etc. displayed on a screen with his or her finger or a stylus pen, an intuitive operation can be performed as an easily operable interface.

The touch panel accepts the menu or the button displayed at the touched point as an operation target when the user touches for a moment on the screen. There is a touch panel proposed to display a cursor near the touched point when the user touches the screen. The technology relating to the touch panel is described in, for example, Japanese Laid-open Patent Publication No. 6-51908 and Japanese Laid-open Patent Publication No. 2001-195187.

When such a touch panel is operated, a user moves his or her finger or pen while touching the screen. The touch panel moves a cursor according to the movement of the user touched point, and when the user finishes the touching operation on the screen, the touch panel accepts as an operation target the menu or the button pointed to by the cursor immediately before the operation.

With the above-mentioned touch panel, it is necessary to determine with accuracy the menu or the button corresponding to the user touched point. For example, when the touch panel accepts a user-unintended menu or button as an incorrect operation target, the equipment performs a user-unintended operation. In this case, the operation is an incorrect, and it is necessary for the user to perform the touching operation again, thereby degrading the operability.

### SUMMARY

According to an aspect of an invention, a non-transitory computer readable medium stores a computer program which enables a computer to perform an input method for accepting input information by a touching operation on a touch target. The input method includes: acquiring information about the touched region in which the touching operation is performed on the touch target; determining a display mode of an operation target indicator displayed with the touching operation according to the information about the touched region; outputting a display instruction for displaying the operation target indicator in the determined display mode; moving the displayed operation target indicator according to the movement of the touched region; and accepting the input information corresponding to a display position of the operation target indicator when the touching operation is finished.

According to another aspect of an invention, an input device which accepts input information by a touching operation performed on a touch target, includes a display unit; a touch sensor; a storage unit; a touched region acquisition unit to acquire information about the touched region in which the touching operation is performed on the touch target using the touch sensor; a determination unit to determine a display mode of an operation target indicator displayed with the touching operation by referring to information stored in the storage unit according to the information about the touched region acquired by the touched region acquisition unit; an output unit to output a display instruction for displaying the operation target indicator on the display unit in the display mode determined by the determination unit; a designation unit to designate an operation target based on a display position of the operation target indicator when the touching operation is finished; a notification unit to notify the designated operation target of the input information by the touching operation; a movement unit to move the displayed operation target indicator according to the movement of the touched region; and an acceptance unit to accept the input information corresponding to the display position of the operation target indicator when the touching operation is finished.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an example of the configuration of the electric equipment according to the embodiment 1;

FIG. 2 is a schematic diagram of the stored contents of the correction value DB according to the embodiment 1;

FIG. 3 is a functional block diagram of the electric equipment according to the embodiment 1;

FIGS. 4A and 4B are schematic diagrams of an example of a display screen according to the embodiment 1;

FIG. 5 and FIG. 6 are flowcharts of the procedure of the input information accepting process according to the embodiment 1;

FIGS. 7A and 7B are schematic diagrams of an example of a display screen according to the embodiment 2;

FIG. 8 and FIG. 9 are flowcharts of the procedure of the input information accepting process according to the embodiment 2;

FIG. 10 is a schematic diagram of the stored contents of a lower limit DB;

FIG. 11 is a functional block diagram of the electric equipment according to the embodiment 3;

FIG. 12 and FIG. 13 are flowcharts of the procedure of the input information accepting process according to the embodiment 3;

FIG. 14 is a schematic diagram of the stored contents of the correction value DB according to the embodiment 4;

FIG. 15 is a functional block diagram of the electric equipment according to the embodiment 4;

FIG. 16 and FIG. 17 are flowcharts of the procedure of the input information accepting process according to the embodiment 4;

FIGS. 18A and 18B are schematic diagrams of the appearance of the electric equipment according to the embodiment 5;

FIG. 19 is a block diagram of an example of the configuration of the electric equipment according to the embodiment 5;

FIG. 20 is a schematic diagram of the stored contents of the correction value DB according to the embodiment 5;

FIG. 21 is a functional block diagram of the electric equipment according to the embodiment 6;

FIGS. 22A and 22B are schematic diagrams for explanation of a clustering process;

FIG. 23 and FIG. 24 are flowcharts of the procedure of the input information accepting process according to the embodiment 6;

FIG. 25 is a functional block diagram of the electric equipment according to the embodiment 7;

FIGS. 26A, 26B and 27A-27D are schematic diagrams for explanation of an updating process of a correction value DB;

FIG. 28 and FIG. 29 are flowcharts of the procedure of the input information accepting process according to the embodiment 7;

FIG. 30 is a flowchart of the procedure of the input information accepting process according to the embodiment 7; and

FIG. 31 is a block diagram of an example of the configuration of the electric equipment according to the embodiment 8.

### DESCRIPTION OF EMBODIMENTS

The computer program, the input device, and the input method of the present application are described below with reference to the drawing of each embodiment using electric equipment provided with a touch panel as an example. The computer program of the present application maybe provided for each electric equipment as UI middleware as the middleware for a user interface. However, the computer program of the present application is not limited to such a configuration, and can be included in an OS (operating system) software such as Windows (registered trade mark) and Linux etc. In addition, the computer program of the present application can also be included in computer software or application software such as a mailer etc.

The input device of the present application is realized by executing the computer program of the present application by enabling the electric equipment provided with a touch panel to read the program.

The electric equipment provided with a touch panel can be, for example, a well-known tablet personal computer, a terminal device used for a cloud computing system, etc. An electric equipment provided with a touch panel is a mobile terminal such as a mobile telephone, a PHS (personal handy-phone system), a PDA (personal digital assistant), a mobile game machine, etc. Furthermore, an electric equipment provided with a touch panel can be a copying machine, a printer, a facsimile device, a multi functional machine, a car navigation device, a digital camera, etc.

The input device according to the present application can also be implemented for a multimedia station device capable of downloading various data by being installed in a convenience store etc., an automatic teller machine (ATM), etc. Furthermore, the input device according to the present application can be implemented for various vending machines, automatic ticket issuing systems, various signboards, order systems installed in restaurants, lending systems installed in libraries, etc.

### Embodiment 1

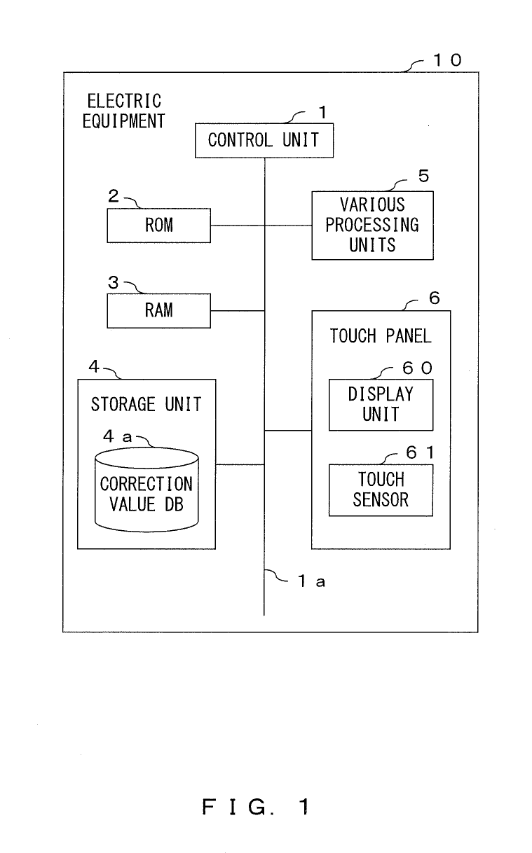

Described below is an electric equipment according to the embodiment 1. FIG. 1 is a block diagram of an example of the configuration of the electric equipment according to the embodiment 1. Electric equipment 10 according to the embodiment 1 is, for example, a personal computer, and includes a control unit 1, ROM (read only memory) 2, RAM (random access memory) 3, a storage unit 4, various processing units 5, a touch panel 6, etc. These hardware components are interconnected through a bus 1a.

The electric equipment 10 according to the embodiment 1 stores a computer program of the present application in the ROM 2 or the storage unit 4 in advance, and realizes the operation as the input device of the present application by the control unit 1 executing the computer program. When the computer program of the present application is stored in the ROM 2 as UI middleware, the control unit 1 executes the UI middleware on the OS after starting up the OS software.

When the computer program of the present application is included in the OS software and stored in the ROM 2, the control unit 1 also executes the computer program of the present application when the OS software is executed. In addition, when the computer program of the present application is included in application software and stored in the ROM 2 or the storage unit 4, the control unit 1 also executes the computer program of the present application when the application software is executed.

The control unit 1 is a CPU (central processing unit), an MPU (micro processor unit), etc., and reads the control program stored in advance in the ROM 2 or the storage unit 4 to the RAM 3, and executes the program. The control unit 1 also controls the operation of each of the above-mentioned hardware components. The ROM 2 stores in advance various control programs necessary for operating as the electric equipment 10. The RAM 3 is SRAM, flash memory, etc., and temporarily stores various data generated when the control unit 1 executes the control program.

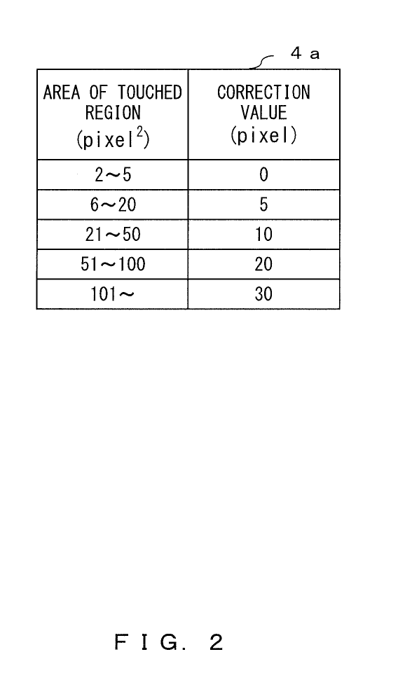

The storage unit 4 is, for example, a hard disk drive, flash memory, etc. The storage unit 4 stores in advance various control programs necessary for operating as the electric equipment 10. The storage unit 4 also stores a correction value database (hereinafter referred to as a correction value DB) 4a as illustrated in FIG. 2. The correction value DB 4a is described later in detail.

The various processing units 5 perform various processes at an instruction from the control unit 1. The various processes are those executable by the electric equipment 10, and if the electric equipment 10 is a personal computer, the personal computer can execute the processes. If the electric equipment 10 is a mobile telephone, the various processing units 5 performs, for example, a communicating process of sending and receiving audio data, a data communication process of sending and receiving e-mail, etc.

The touch panel 6 includes a display unit 60 and a touch sensor 61. Each of the display unit 60 and the touch sensor 61 is connected to the bus 1a.

The display unit 60 is, for example, a liquid crystal display (LCD), and displays an operation state of the electric equipment 10, the information to be reported to a user, etc. at an instruction from the control unit 1. In addition, the display unit 60 displays various buttons, menus, etc. associated with various types of information to be accepted by the electric equipment 10 through the touch panel 6.

The touch sensor 61 detects whether or not a user has performed a touching operation on the touch panel 6. Practically, the touch sensor 61 is, for example, a pressure sensor for detecting the pressure applied to the sensor, a capacitance sensor for detecting a change in capacitance on the point at which the pressing operation is performed, etc. The touch sensor 61 transmits a detection signal changeable by a user performing the touching operation on the touch panel 6 to the control unit 1. The touch sensor 61 can also be any of the various sensors for detecting the touched point on the touch panel 6 using infrared radiation, ultrasonics, etc. The touch sensor 61 can also be an image processing sensor for capturing an image of the surface of the touch panel 6 using a camera, and detecting a touched point on the touch panel 6 based on the captured image.

FIG. 2 is a schematic diagram of the stored contents of the correction value DB 4a according to the embodiment 1. As illustrated in FIG. 2, the correction value DB 4a stores a correction value associated with the area of the touched region. The area of the touched region is the area of the region of the touch panel 6 touched by a user when the user performs the touching operation on the touch panel 6. A correction value is a value used to determine the display mode of the cursor (operation target indicator) displayed while the user performs the touching operation on the touch panel 6. The correction value DB 4a stores in advance the optimum correction value for the area of touched region. Although an appropriate range is set as a value of the area of a touched region in the correction value DB 4a illustrated in FIG. 2, a correction value can be set for each pixel².

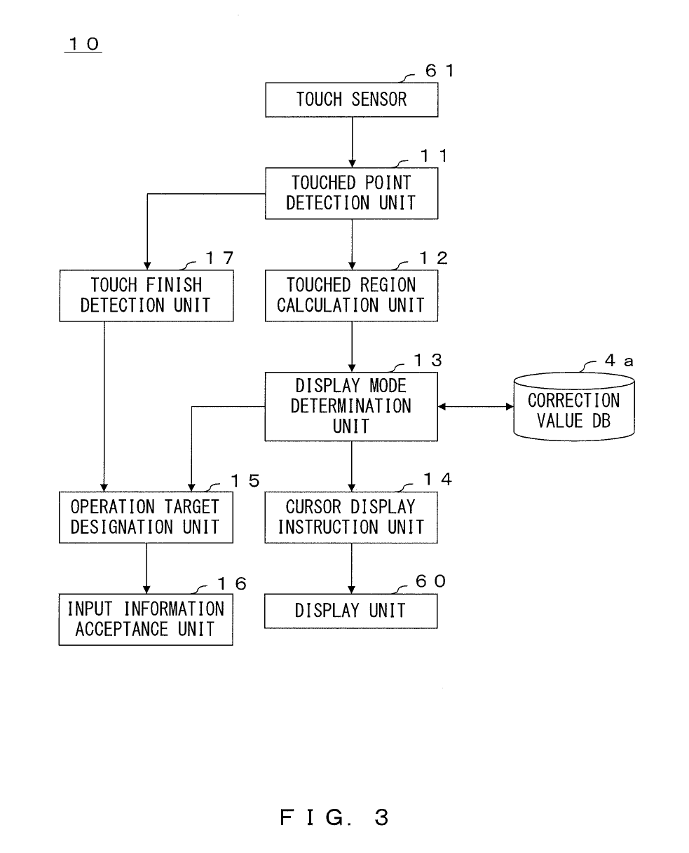

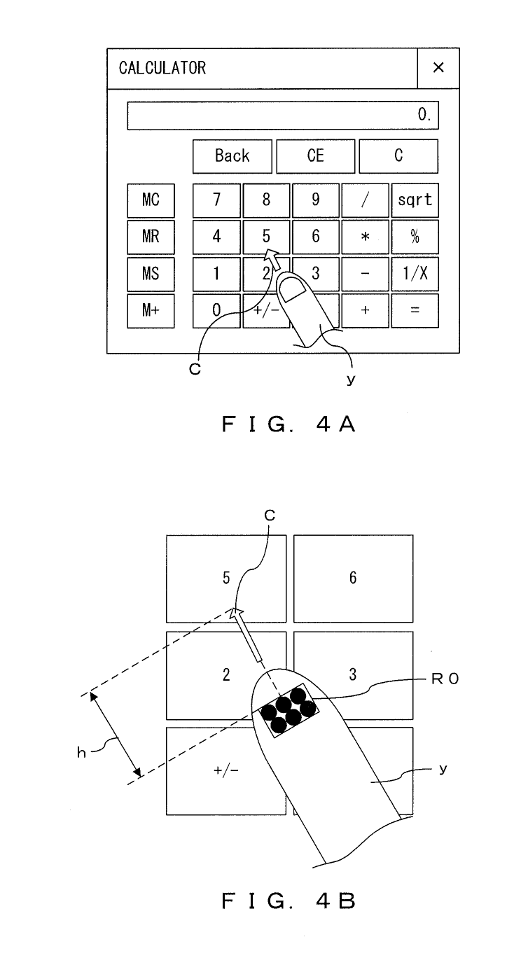

Described below is the function realized by the control unit 1 executing the control program stored in the ROM 2 or the storage unit 4 in the electric equipment 10 according to the embodiment 1. FIG. 3 is a functional block diagram of the electric equipment 10 according to the embodiment 1. FIGS. 4A and 4B are schematic diagrams of an example of a display screen according to the embodiment 1.

FIG. 4A is an example of a screen displayed on the touch panel 6 when calculator software is executed by the electric equipment 10, and illustrates the state in which a user performs the touching operation on the 6 with his or her finger y. FIG. 4A illustrates an arrow shaped cursor c, but the cursor c is not displayed on the touch panel 6 before the finger y of the user touches the touch panel 6. FIG. 4B is an enlarged point on which the user performs the touching operation in the example of the screen illustrated in FIG. 4A. The black dots in FIG. 4B illustrate the touched point on the touch panel 6 touched by the finger y of the user.

In the electric equipment 10 according to the embodiment 1, the control unit 1 realizes the functions of a touched point detection unit 11, a touched region calculation unit 12, a display mode determination unit 13, a cursor display instruction unit 14, an operation target designation unit 15, an input information acceptance unit 16, a touch finish detection unit 17, etc. by executing the control program stored in the ROM 2 or the storage unit 4.

The touched point detection unit 11 acquires a detection signal output from the touch sensor 61. The touched point detection unit 11 detects the point where the user performs the touching operation on the touch panel 6 according to the detection signal from the touch sensor 61. At this time, the touched point detection unit 11 acquires the point (touched point) on which the user performs the touching operation as the information (coordinate value) about the coordinate with respect to a specified reference point.

In this example, the touched point detection unit 11 acquires the coordinate value of each touched point indicated by the black dots in FIG. 4B. The touched point detection unit 11 transmits the coordinate values of all detected touched points to the touched region calculation unit 12 and the touch finish detection unit 17. The reference point (0, 0) is, for example, the point at the upper left end of the display area of the touch panel 6. The coordinate value of each touched point is expressed by the coordinate values (x, y) using the right direction from the reference point (0, 0) as the x coordinate axis and the downward direction as the y coordinate axis. The point at the upper right end, at the lower left end, or the lower right end of the display area of the touch panel 6 may also be used as the reference point.

The touched region calculation unit 12 acquires the coordinate values of all touched points from the touched point detection unit 11. The touched region calculation unit (region acquisition unit) 12 designates the minimum rectangular (touched region) including all touched points based on the coordinate values of all touched points, and calculates the area of the designated touched region. In FIG. 4B, the touched region calculation unit 12 designates the minimum touched region R0 including all black dots, and calculates the area of the designated touched region R0. The touched region calculation unit 12 notifies the display mode determination unit 13 of the shape and the area of the designated touched region R0.

The shape of the touched region R0 is notified using the coordinate value of each vertex of the touched region R0. When only the coordinate value of one touched point is acquired from the touched point detection unit 11, the touched region calculation unit 12 notifies the display mode determination unit 13 of the coordinate value acquired from the touched point detection unit 11 as the shape of the touched region R0.

The display mode determination unit 13 acquires the shape and the area of the touched region R0 notified by the touched region calculation unit 12. The display mode determination unit (determination unit) 13 determines the display mode of the cursor displayed on the display unit 60 based on the acquired shape and area of the touched region R0. The display mode determination unit 13 determines, for example, the coordinate value of the position of the tip of the cursor and the direction pointed by the cursor as the display mode of the cursor.

The display mode determination unit 13 first designates the correction value depending on the acquired area of the touched region R0 based on the stored contents of the correction value DB 4a. For example, the display mode determination unit 13 designates the range including the area of the touched region R0 in the correction value DB 4a, and reads the correction value corresponding to the designated range from the correction value DB 4a.

The correction value DB 4a does not store the correction value corresponding to “area=1”. Therefore, when “1” is received from the touched region calculation unit 12 as the area of the touched region R0, the display mode determination unit 13 cannot designate the range including the area of the touched region R0 in the correction value DB 4a.

Therefore, when the display mode determination unit 13 acquires the shape and the area of the touched region R0, it first determines whether or not the acquired area is smaller than the minimum value (“2” in FIG. 2) of the area of the touched region stored in the correction value DB 4a. When the display mode determination unit 13 determines that the acquired area is smaller than the minimum value of the touched region stored in the correction value DB 4a, it notifies the operation target designation unit 15 of the coordinate value of the touched point notified by the touched region calculation unit 12 as the shape of the touched region R0.

The stored contents of the correction value DB 4a are not limited to the example illustrated in FIG. 2, or the minimum value of the area of the touched region stored in the correction value DB 4a is also not limited to “2”. For example, assume that the minimum value of the area of the touched region stored in the correction value DB 4a is “4”. In this case, when the area of the touched region R0 notified from the touched region calculation unit 12 is 1 through 3, the display mode determination unit 13 notifies the operation target designation unit 15 of the shape of the touched region R0 notified from the touched region calculation unit 12. The display mode determination unit 13 notifies the operation target designation unit 15 of the coordinate value of each touched point notified from the touched region calculation unit 12 as the shape of the touched region R0.

When it is determined that the acquired area is equal to or exceeds the minimum value of the area of the touched region stored in the correction value DB 4a, the display mode determination unit 13 reads a corresponding correction value depending on the acquired area of the touched region R0 from the correction value DB 4a.

Next, the display mode determination unit 13 calculates the coordinate value of the center of the upper long side of the touched region R0 based on the shape of the touched region R0 notified from the touched region calculation unit 12. The display mode determination unit 13 calculates the coordinate value of the position at the distance of the correction value read from the correction value DB 4a in the direction perpendicular to the upper long side of the touched region R0 from the center of the long side. The position at the distance of the correction value from the center of the upper long side of the touched region R0 is the position of the tip of the arrow shaped cursor.

The display mode determination unit 13 notifies the cursor display instruction unit 14 of the coordinate value of the position of the tip of the cursor and the coordinate value of the center of the upper long side of the touched region R0. The direction of the line connecting the position of the tip of the cursor and the center of the long side of the touched region R0 is the direction pointed by the cursor. The display mode determination unit 13 notifies the operation target designation unit 15 of the coordinate value of the position of the tip of the cursor.

The cursor display instruction unit 14 acquires the coordinate value of the position of the tip of the cursor and the coordinate value of the center of the long side of the touched region R0 from the display mode determination unit 13. The cursor display instruction unit (output unit) 14 outputs to the display unit 60 a display instruction for display of the cursor in the display mode notified from the display mode determination unit 13. For example, the cursor display instruction unit 14 defines the notified coordinate value of the position of the tip of the cursor as the coordinate value of the position of the tip of the cursor, and outputs to the display unit 60 a display instruction to arrange the cursor on the line connecting the position of the tip of the cursor and the center of the long side of the touched region R0.

Thus, the display unit 60 displays the cursor c having a tip at the position away from the touched region R0 of the user finger y by the distance of the correction value h depending on the area of the touched region R0.

The information about the length, shape of the tip, etc. of the cursor C is stored in advance in the ROM 2 or the storage unit 4. Therefore, the cursor display instruction unit 14 reads the information about the cursor stored in the ROM 2 of the storage unit 4, and outputs to the display unit 60 a display instruction of the cursor C in the shape indicated by the read information.

The touched point detection unit 11, the touched region calculation unit 12, the display mode determination unit 13, and the cursor display instruction unit 14 perform the above-mentioned processes while the detection signal is output from the touch sensor 61. Thus, an appropriate cursor C is displayed depending on the area and position of the touched region R0 when a user performs the touching operation.

When the display mode determination unit 13 notifies the operation target designation unit 15 of the coordinate value of the touched point as the shape of the touched region R0, the operation target designation unit 15 designates the operation target corresponding to the touched point based on the notified coordinate value of the touched point.

The information about the display position, the display size, etc. of the operation target such as an operation button, a menu, etc. displayed on the touch panel 6 is set in an application program. The information about the display position of each operation target is, for example, the coordinate value of the upper left point of the display area of the operation target, and is expressed by the coordinate value (x, y) using the right direction from the reference point (0, 0) as the x coordinate axis and the downward direction as the y coordinate axis. The reference point (0, 0) is, for example, the upper left point of the display area of the touch panel 6, but the upper right point, the lower left point, or the lower right point of the display area of the touch panel 6 may also be used as a reference point.

Therefore, the operation target designation unit 15 acquires the information about the display position of each operation target, and designates the operation target including the touched point in the display area based on the acquired information and the coordinate value of the touched point notified from the display mode determination unit 13. When the operation target designation unit 15 designates the operation target including the touched point notified from the display mode determination unit 13 in the display area, it notifies the input information acceptance unit 16 of the designated operation target. When the user performs the touching operation on the point not included in the display area of the operation target, the operation target including the touched point notified from the display mode determination unit 13 in the display area cannot be designated. Therefore, when no operation target can be designated, the operation target designation unit 15 performs no process.

The input information acceptance unit 16 designates the information corresponding to the operation target notified from the operation target designation unit 15, and accepts the designated information as input information. The information corresponding to each operation target is also set in the application program. Thus, when the area of the touched region R0 on which a user performs the touching operation is smaller than the minimum value of the area of the touched region stored in the correction value DB 4a, it is determined that the operation target displayed at the position corresponding to the touched region R0 has been operated by the user.

The touch finish detection unit 17 determines whether or not the touching operation by the user has been finished based on the coordinate value of the touched point acquired from the touched point detection unit 11. For example, when the notification of the coordinate value of the touched point from the touched point detection unit 11 has been finished, the touch finish detection unit 17 detects that the touching operation by the user has been finished. When the touch finish detection unit 17 detects the finish of the touching operation by the user, it notifies the operation target designation unit 15 of the finish of the touching operation.

As described above, the operation target designation unit 15 is notified of the coordinate value of the position of the tip of the cursor by the display mode determination unit 13. If the touch finish detection unit 17 notifies the operation target designation unit 15 of the finish of the touching operation while the coordinate value of the position of the tip of the cursor is being notified, the operation target designation unit 15 designates the operation target corresponding to the position of the tip based on the notified coordinate value of the position of the tip of the cursor.

For example, the operation target designation unit 15 designates a operation target including the tip of the cursor in the display area of a the operation target based on the information about the display position of each operation target and the coordinate value of the position of the tip of the cursor notified from the display mode determination unit 13. When the operation target designation unit 15 designates the operation target including the tip of the cursor in the display area of the operation target, it notifies the input information acceptance unit 16 of the designated operation target. When the touching operation is finished while the cursor points to the portion not the display area of the operation target, the operation target including the tip of the cursor in the display area of the operation target cannot be designated. Therefore, when the operation target cannot be designated, the operation target designation unit 15 performs no process.

The input information acceptance unit 16 designates the information corresponding to the operation target notified from the operation target designation unit 15, and accepts the designated information as input information. Thus, it is determined that the operation target displayed at the position pointed to by the cursor C when the touching operation by the user is finished has been operated by the user.

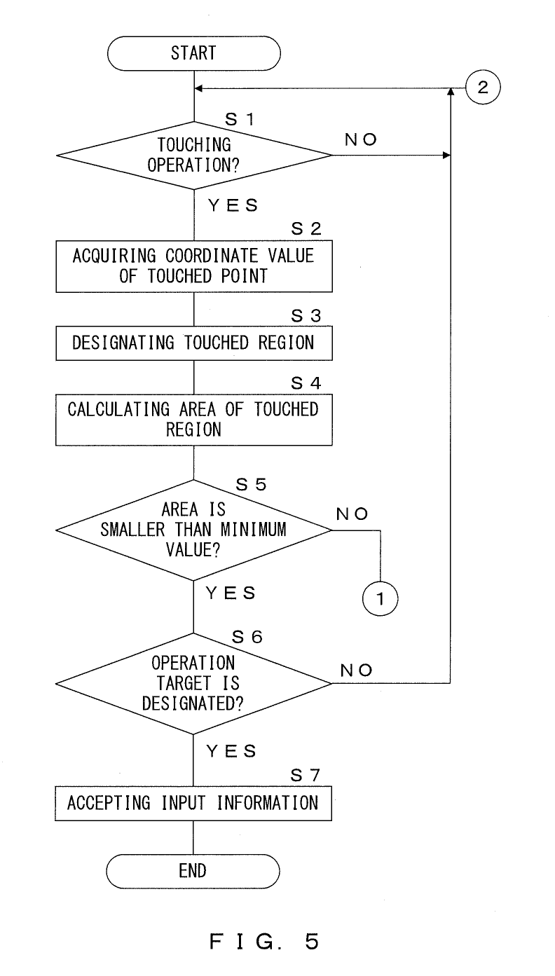

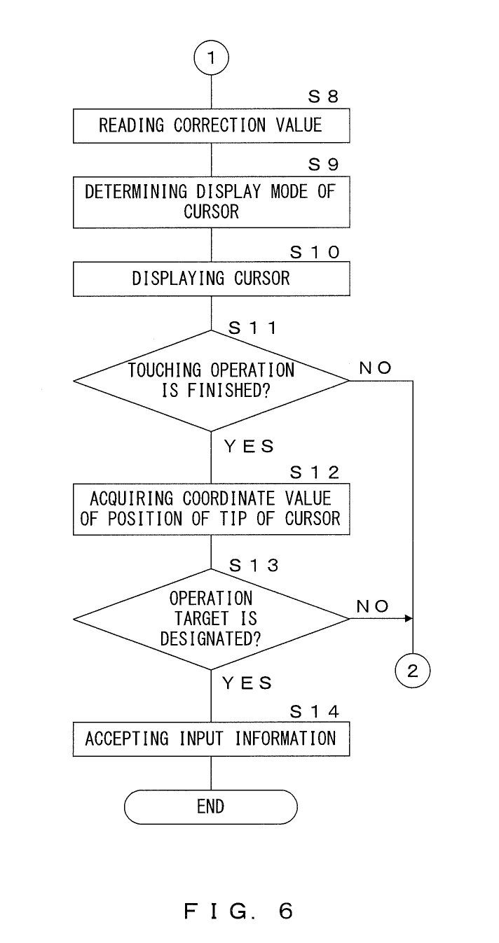

The process performed by the control unit 1 when a user performs the touching operation in the electric equipment 10 according to the embodiment 1 is described below with reference to a flowchart. The processes performed by the control unit 1 when the user performs the touching operation are the process of displaying a cursor, and the process of accepting the input information by the touching operation. FIG. 5 and FIG. 6 are the flowcharts of the procedure of the input information accepting process according to the embodiment 1. The processes below are performed by the control unit 1 according to the control program stored in the ROM 2 or the storage unit 4 of the electric equipment 10.

The control unit 1 detects whether or not the touch panel 6 is touched by a user according to the detection signal from the touch sensor 61 (S1). If it is not detected that the touching operation has been performed (NO in S1), a standby state is entered while performing other processes. If the touching operation has been detected (YES in S1), then the control unit 1 acquires the coordinate value of the touched point on which the user performs the touching operation (S2).

The control unit 1 designates a rectangular touched region R0 of the minimum size including all touched points based on the acquired coordinate value of the touched point (S3) The control unit 1 calculates the area of the designated touched region R0. The control unit 1 determines whether or not the calculated area is smaller than the minimum value of the area of the touched region stored in the correction value DB 4a (S5). When it is determined that the calculated area is smaller than the minimum value (YES in S5), the control unit 1 tries to designate an operation target corresponding to the touched region R0 designated instep S3, and determines whether or not the corresponding operation target has been designated (S6). For example, the control unit 1 tries to designate an operation target including the touched region R0 in the display area of the operation target, and determines whether or not the operation target has been successfully designated.

When the control unit 1 determines that the operation target has not been designated (NO in S6), control is returned to step S1. When it is determined that the operation target has been designated (YES in S6), the control unit 1 accepts the input information corresponding to the designated operation target (S7), thereby terminating the process.

When the control unit 1 determines that the area calculated in step S4 is equal to or exceeds the minimum value (NO in S5), it reads a correction value corresponding to the calculated area from the correction value DB 4a (S8). The control unit 1 determines the display mode of the cursor C to be displayed on the touch panel 6 based on the shape of the touched region R0 designated in step S3 and the correction value read from the correction value DB 4a (S9). For example, the control unit 1 calculates the coordinate value of the center of the upper long side of the touched region R0 and the coordinate value of the position at a distance of the correction value read from the correction value DB 4a in the direction perpendicular to the upper long side from the center of the upper long side.

The control unit 1 outputs to the display unit 60 a display instruction for display of the cursor C in the display mode determined in step S9, and displays the cursor C on the display unit 60 (S10). The control unit 1 monitors according to the detection signal from the touch sensor 61 whether or not the user touching operation has been finished (S11). If it is not detected that the touching operation has been finished (NO in S11), control is returned to step S1.

The control unit 1 repeats the processes in steps S1 through S10 until it is detected that the touching operation has been finished. When it is detected that the touching operation has been finished (YES in S11), the control unit 1 acquires the coordinate value of the position of the tip of the cursor C displayed at this timing (S12). The control unit 1 tries to designate an operation target corresponding to the acquired position of the tip of the cursor C, and determines whether or not the corresponding operation target has been designated (S13). For example, the control unit 1 tries to designate an operation target including the position of the tip of the cursor C in the display area of the operation target, and determines whether or not the target has been designated.

The control unit 1 returns control to step S1 when it is determined that the operation target cannot be designated (NO in S13). When it is determined that the operation target has been determined (YES in S13), the control unit 1 accepts the input information corresponding to the designated operation target (S14), and terminates the process.

As described above, according to the embodiment 1, while a user performs the touching operation, the cursor is displayed at the position depending on the area of the touched region where the user touches the touch panel 6. Thus, while preventing the cursor from being displayed at the position where the cursor is hidden by a finger of the user, the cursor can be prevented from being displayed away from the finger of the user. Therefore, the operability is improved for the touch panel 6.

According to the embodiment 1, when the area of the region touched by the user is smaller than the minimum value of the area of the touched region stored in the correction value DB 4a, the cursor is not to be displayed, but the operation target displayed at the point touched by the user is selected. Thus, for example, when a touching operation is performed with a thin tip such as a pen etc., the operation target displayed at the touched point is selected, thereby realizing an intuitive operation.

The control unit 1 according to the embodiment 1 designates the correction value depending on the area of the user touched region R0 with reference to the correction value DB 4a. However, the correction value may be determined by another method. For example, an equation for calculating a correction value depending on the area of the touched region R0 is set in advance, and the control unit 1 may use the equation to calculate the correction value depending on the area of the touched region R0.

### Embodiment 2

Described below is the electric equipment according to the embodiment 2. Since the electric equipment according to the embodiment 2 can be realized with a configuration similar to that of the electric equipment 10 according to the embodiment 1, the same or similar element is assigned the same reference numeral, and the detailed description is omitted here.

In the embodiment 1, the position of the tip of the cursor is the position at the distance of the correction value designated by the correction value DB 4a from the center of the upper long side of the touched region on which the user touches the touch panel 6. In the embodiment 2, when the area of the touched region is smaller than a specified value, the position of the tip of the cursor is the position at the distance of the correction value designated by the correction value DB 4a from the center of the upper long side of the touched region. When the area of the touched region is equal to or exceeds the specified value, the position of the tip of the cursor is the position at the distance of the correction value designated by the correction value DB 4a from the center of the upper short side of the touched region.

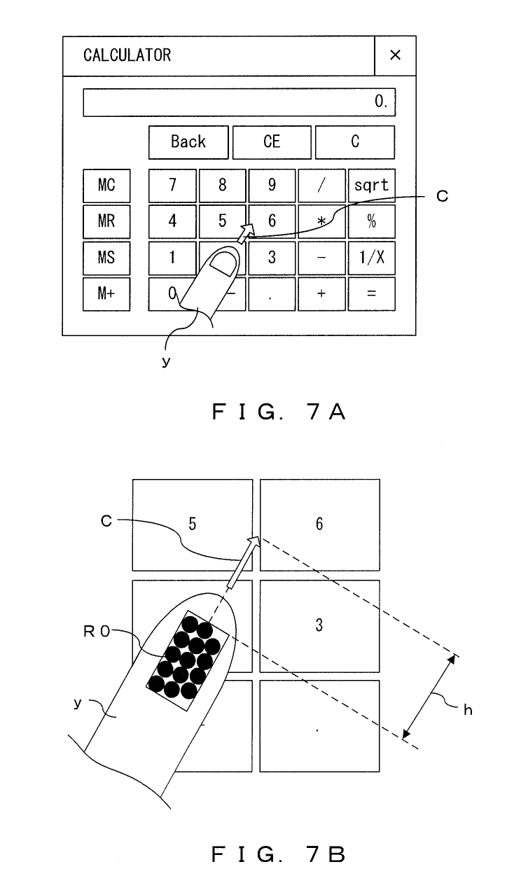

FIGS. 7A and 7B are schematic diagrams of an example of a display screen according to the embodiment 2. FIG. 7A is an example of the screen displayed on the touch panel 6 when calculator software is executed by the electric equipment 10, and illustrates the state in which the user performs the touching operation on the touch panel 6 with his or her finger. FIG. 7B is an enlarged view of the portion touched by the user in the example of the screen illustrated in FIG. 7A. The black dots in FIG. 7B schematically indicate the touched point on the touch panel 6 touched by the finger y of the user.

The display mode determination unit 13 according to the embodiment 2 acquires the shape and the area of the touched region R0 calculated by the touched region calculation unit 12 as with the display mode determination unit 13 according to the embodiment 1. The display mode determination unit 13 according to the embodiment 2 first determines whether or not the acquired area of the touched region R0 is smaller than the minimum value of the area of the touched region stored in the correction value DB 4a. When the acquired area is smaller than the minimum value, the display mode determination unit 13 notifies the operation target designation unit 15 of the coordinate value of the touched point received from the touched region calculation unit 12 as the shape of the touched region R0.

When the display mode determination unit 13 determines that the acquired area is equal to or exceeds the minimum value, then it reads the correction value depending on the acquired area of the touched region R0 from the correction value DB 4a. Next, the display mode determination unit 13 determines whether or not the acquired area of the touched region R0 is equal to or exceeds a specified value. The specified value is stored in advance in the ROM 2 or the storage unit 4, and is, for example, 30 pixel². The specified value may be configured by a user.

When the acquired area is equal to or exceeds the specified value, the display mode determination unit 13 calculates the coordinate value of the center of the upper short side of the touched region R0 based on the shape of the touched region R0 notified from the touched region calculation unit 12. The display mode determination unit 13 calculates the coordinate value of the position at the distance of the correction value read from the correction value DB 4a in the direction perpendicular to the upper short side from the center of the upper short side of the touched region R0. The position at the distance of the correction value from the center of the upper short side of the touched region R0 is defined as the position of the tip of the cursor.

The display mode determination unit 13 notifies the cursor display instruction unit 14 of the coordinate value of the position of the tip of the cursor and the coordinate value of the center of the upper short side of the touched region R0. The direction connecting the position of the tip of the cursor and the center of the short side of the touched region R0 is defined as the direction to be indicated by the cursor. In addition, the display mode determination unit 13 notifies the operation target designation unit 15 of the coordinate value of the position of the tip of the cursor.

On the other hand, when it is determined that the acquired area is smaller than the specified value (for example, 30 pixel²), the display mode determination unit 13 calculates the coordinate value of the center of the upper long side of the touched region R0 based on the shape of the touched region R0 notified from the touched region calculation unit 12. The display mode determination unit 13 calculates the coordinate value of the position at the distance of the correction value read from the correction value DB 4a in the direction perpendicular to the upper long side from the center of the upper long side of the touched region R0. The position at the distance of the correction value from the center of the upper long side of the touched region R0 is defined as the position of the tip of the cursor.

The display mode determination unit 13 notifies the cursor display instruction unit 14 of the coordinate value of the position of the tip of the cursor and the coordinate value of the center of the upper long side of the touched region R0. The direction connecting the position of the tip of the cursor and the center of the long side of the touched region R0 is defined as the direction to be indicated by the cursor. The display mode determination unit 13 notifies the operation target designation unit 15 of the coordinate value of the position of the tip of the cursor.

The cursor display instruction unit 14 according to the embodiment 2 acquires from the display mode determination unit 13 the coordinate value of the position of the tip of the cursor and the coordinate value of the center of the short (or long) side of the touched region R0. The cursor display instruction unit 14 defines the notified coordinate value of the position of the tip of the cursor as the coordinate value of the position of the tip of the cursor, and outputs to the display unit 60 a display instruction to arrange the cursor on the line connecting the position of the tip of the cursor and the center of the short (long) side of the touched region R0.

Thus, when the area of the touched region R0 of the user finger y is equal to or exceeds a specified value (30 pixel²) , the cursor C having a tip at the position away from the upper short side of the touched region R0 by the distance of the correction value h is displayed as illustrated in FIG. 7B. When the area of the touched region R0 of the user finger y is smaller than the specified value, the cursor C having a tip at the position away from the upper long side of the touched region R0 by the distance of the correction value h is displayed as illustrated in FIG. 4B.

When the user performs the touching operation with his or her finger y, and if the area of the touched region R0 is equal to or exceeds a specified value, then there is a strong possibility that the touching operation is performed using a larger portion of the finger (such as with a ball of the finger). On the other hand, when the area of the touched region R0 is smaller than the specified value, then there is a strong possibility that the touching operation is performed using the finger tip. Therefore, depending on whether or not the area of the touched region R0 is smaller than the specified value, the direction of the finger y matches the direction of the cursor C by displaying the cursor C perpendicularly with respect to the upper short side or upper long side of the touched region R0 although any portion of the finger y is used in the touching operation. Therefore, a more visible cursor C can be displayed depending on the state of the user finger y.

Each component other than the display mode determination unit 13 of the embodiment 2 performs processes similar to the embodiment 1.

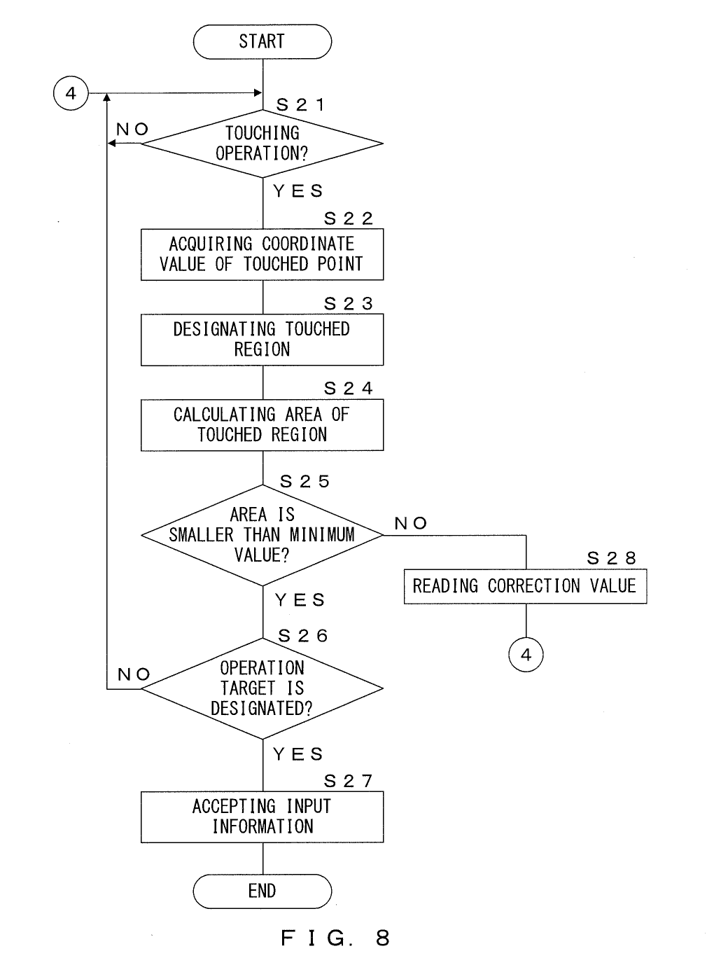

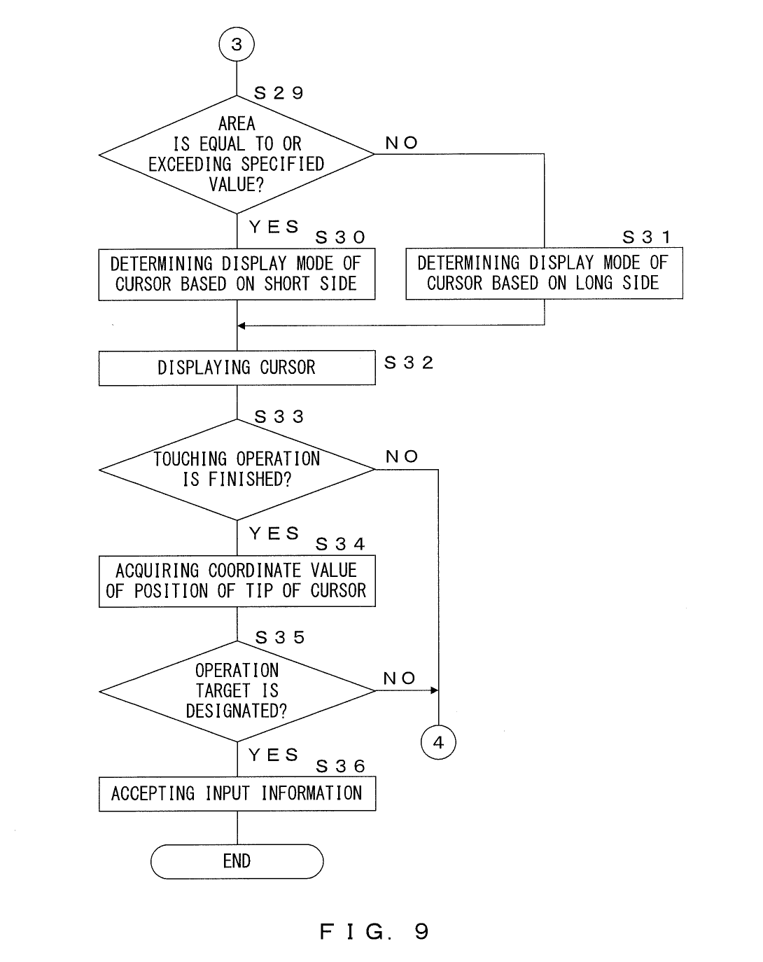

The process performed by the control unit 1 while a user performs the touching operation in the electric equipment 10 according to the embodiment 2 is described below with reference to the flowchart. FIG. 8 and FIG. 9 are flowcharts of the procedure of the input information accepting process according to the embodiment 2. The following process is performed by the control unit 1 according to the control program stored in the ROM 2 or the storage unit 4 of the electric equipment 10.

The control unit 1 detects whether or not the user has performed the touching operation on the touch panel 6 according to the detection signal from the touch sensor 61 (S21). If the touching operation has not been detected (NO in S21), the process enters the standby state while performing other processes. If the touching operation has been detected (YES in S21), the control unit 1 acquires the coordinate value of the touched point on which the user performs the touching operation (S22).

The control unit 1 designates the minimum rectangular touched region R0 including all touched points based on the coordinate value of the acquired touched point (S23). The control unit 1 calculates the area of the touched region R0 (S24). The control unit 1 determines whether or not the calculated area is smaller than the minimum value of the area of the touched region stored in the correction value DB 4a (S25). When it is determined that the calculated area is smaller than the minimum value (YES in S25), the control unit 1 tries to designate an operation target corresponding to the touched region R0 designated in step S23, and determines whether or not the corresponding operation target can be designated (S26). Practically, the control unit 1 designates the operation target including the touched region R0 in the display area, and determines whether or not the target can be successfully designated.

When the control unit 1 determines that the operation target cannot be designated (NO in S26), control is returned to step S21. When the control unit 1 determines that the operation target has been designated (YES in S26), then it accepts the input information corresponding to the designated operation target (S27), and the process terminates.

When it is determined that the area calculated in step S24 is equal to or exceeds the minimum value (NO in S25), the control unit 1 reads the correction value corresponding to the calculated area from the correction value DB 4a (S28). The control unit 1 determines whether or not the area calculated in step S24 is equal to or exceeds a specified value (for example, 30 pixel²) (S29).

When it is determined that the area is equal to or exceeds the specified value (YES in S29), the control unit 1 determines the display mode of the cursor C using a short side of the touched region R0 with respect to the shape of the touched region R0 designated in step S23 and the correction value read from the correction value DB 4a (S30). For example, the control unit 1 calculates the coordinate value of the center of the upper short side of the touched region R0 and the coordinate value of the position at a distance of the correction value read from the correction value DB 4a in the direction perpendicular to the upper short side from the center of the upper long side of the touched region R0.

When the area is smaller than the specified value (NO in S29), the control unit 1 determines the display mode of the cursor C using a long side of the touched region R0 with respect to the shape of the touched region R0 designated in step S23 and the correction value read from the correction value DB 4a (S31). For example, the control unit 1 calculates the coordinate value of the center of the upper long side of the touched region R0 and the coordinate value of the position at a distance of the correction value read from the correction value DB 4a in the direction perpendicular to the upper long side from the center of the upper long side of the touched region R0.

The control unit 1 outputs to the display unit 60 a display instruction for display of the cursor C in the display mode determined in step S30 or S31, and displays the cursor C on the display unit 60 (S32). The control unit 1 monitors whether or not the touching operation has been finished by the user (S33), and if it has not detected that the touching operation has been finished (NO in S33), control is returned to step S21.

The control unit 1 repeats the processes in steps S21 through S32 until the termination of the touching operation is detected. When it is detected that the touching operation has been finished (YES in S33), the control unit 1 acquires the coordinate value of the position of the tip of the cursor C displayed at this timing (S34). The control unit 1 tries to designate an operation target corresponding to the acquired position of the tip of the cursor C, and determines whether or not the corresponding operation target has been designated (S35). For example, the control unit 1 tries to designate an operation target including the position of the tip of the cursor C in the display area of the operation target, and determines whether or not the operation target has been designated.

When the control unit 1 determines that the operation target cannot be designated (NO in S35), control is returned to step S21. When the control unit 1 determines that the operation target has been designated (YES in S35), it accepts the input information corresponding to the designated operation target (S36), and terminates the process.

As described above, in the embodiment 2, when the user performs the touching operation, a cursor is displayed in the position depending on the area of the region touched by the user on the touch panel 6. Thus, while preventing the cursor from being displayed at the position where the cursor is hidden by the finger of the user, the cursor can be prevented from being displayed away from the finger of the user. In addition, depending on whether or not the area of the touched region of the user is smaller than a specified value, the display position of the cursor is changed (with respect to a short side or a long side of the touched region). Thus, since the cursor can be displayed in the direction depending on the use state of the user finger, a cursor which can be easily recognized by the user can be displayed.

### Embodiment 3

Described below is the electric equipment according to the embodiment 3. Since the electric equipment according to the embodiment 3 can be realized by the configuration similar to the electric equipment 10 of the embodiment 1, the same or similar element is assigned the same reference numeral, and the detailed description is omitted here.

In the embodiment 1, when the area of the region touched by the user on the touch panel 6 is smaller than the minimum value of the area of the touched region stored in the correction value DB 4a, the cursor is not displayed, but the operation target including the touched region in the display area is operated. That is, when the area of the touched region is smaller than the minimum value, the information corresponding to the operation target including the touched region in the display area of the operation target is accepted as the input information.

The electric equipment 10 according to the embodiment 3 detects the minimum size of the operation target (operation button and menu) displayed on the touch panel 6, and changes the minimum value of the area of the touched region used for a reference as to whether or not the cursor is to be displayed depending on the detected minimum size of the operation target.

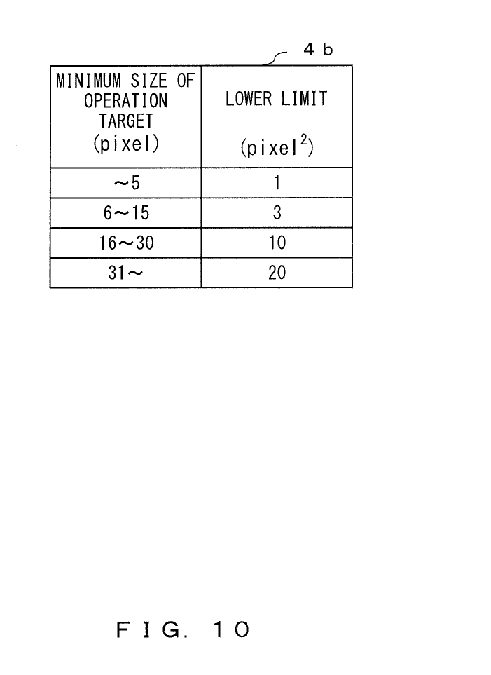

The electric equipment 10 according to the embodiment 3 stores a lower limit database (hereinafter referred to as a lower limit DB) 4b as illustrated in FIG. 10 in the storage unit 4 in addition to each hardware component illustrated in FIG. 1. FIG. 10 is a schematic diagram of the stored contents of the lower limit DB 4b. As illustrated in FIG. 10, the lower limit DB 4b stores the lower limit of the area of the touched region in association with the minimum size of the operation target.

The minimum size of the operation target is, for example, the minimum size (or length) in the vertical direction of each operation target such as an operation button, a menu, etc. displayed on the touch panel 6. The information about the minimum size of an operation target is set in the application program. The lower limit indicates the minimum value of the area of the touched region in which it is assumed that the operation target corresponding to the touched region has been operated without displaying the cursor when the touching operation is performed. In other words, the lower limit indicates a threshold of the area of the touched region to determine whether or not the cursor is to be displayed when the touching operation is performed. The lower limit DB 4b stores in advance an appropriate lower limit for the minimum size of the operation target. In the lower limit DB 4b illustrated in FIG. 10, an appropriate range is set as a value indicating the minimum size of an operation target, but the lower limit may also be set for each pixel. In addition, an equation for calculating the lower limit depending on the minimum size of the operation target may be prepared in advance, and the control unit 1 may calculate the lower limit depending on the minimum size of the operation target using the equation.

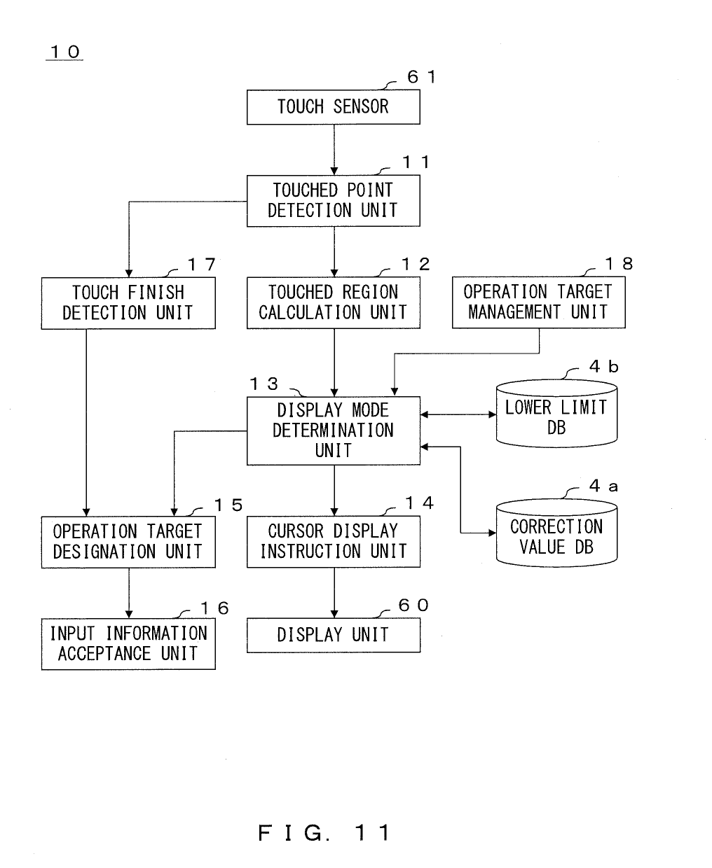

FIG. 11 is a functional block diagram of the electric equipment 10 according to the embodiment 3. In the electric equipment 10 according to the embodiment 3, the control unit 1 realizes the function of an operation target management unit 18 in addition to each function illustrated in FIG. 3.

The operation target management unit 18 acquires from an application program the information about the display position, the display size, etc. of an operation target such as a button, a menu, etc. displayed on the touch panel 6. The information about the display position and the display size of an operation target may be set in an application program or may be stored in advance in the ROM 2 or the storage unit 4 as the system information about the electric equipment 10. The operation target management unit 18 notifies the display mode determination unit 13 of the minimum value (minimum size) in the acquired display sizes of the operation target. The minimum size of the operation target is defined as the minimum size (or length) in the vertical direction of the operation target, but it may also be the minimum size in the horizontal direction of the operation target, and the minimum area of the operation target.

Like the display mode determination unit 13 according to the embodiment 1, the display mode determination unit 13 according to the embodiment 3 acquires the shape and the area of the touched region R0 calculated by the touched region calculation unit 12. In addition, the display mode determination unit 13 according to the embodiment 3 acquires the minimum size of the operation target from the operation target management unit 18. The display mode determination unit 13 according to the embodiment 3 reads from the lower limit DB 4b the lower limit corresponding to the minimum size of the operation target acquired from the operation target management unit 18. Then, the display mode determination unit 13 determines whether or not the area of the touched region R0 acquired from the touched region calculation unit 12 is smaller than the lower limit read from the lower limit DB 4b.

When the display mode determination unit 13 determines that the acquired area is smaller than the lower limit, it notifies the operation target designation unit 15 of the coordinate value of the touched point notified from the touched region calculation unit 12 as the shape of the touched region R0. When the display mode determination unit 13 determines that the acquired area is equal to or exceeds the lower limit, the display mode determination unit 13 reads from the correction value DB 4a the correction value depending on the area of the touched region R0.

The display mode determination unit 13 calculates the coordinate value of the center of the upper long side of the touched region R0 based on the shape of the touched region R0 notified from the touched region calculation unit 12. The display mode determination unit 13 calculates the coordinate value of the position at the distance of the correction value read from the correction value DB 4a from the center of the upper long side of the touched region R0 in the direction perpendicular to the upper long side. The position at the distance of the correction value from the center of the upper long side of the touched region R0 is defined as the position of the tip of the arrow shaped cursor.

The display mode determination unit 13 notifies the cursor display instruction unit 14 of the coordinate value of the position of the tip of the cursor and the coordinate value of the center of the upper long side of the touched region R0. The direction of the line connecting the position of the tip of the cursor and the center of the upper long side of the touched region R0 is defined as the direction to be pointed by the cursor. The display mode determination unit 13 notifies the operation target designation unit 15 of the coordinate value of the position of the tip of the cursor.

Each component other than the display mode determination unit 13 and the operation target management unit 18 according to the embodiment 3 performs processes similar to the embodiment 1.

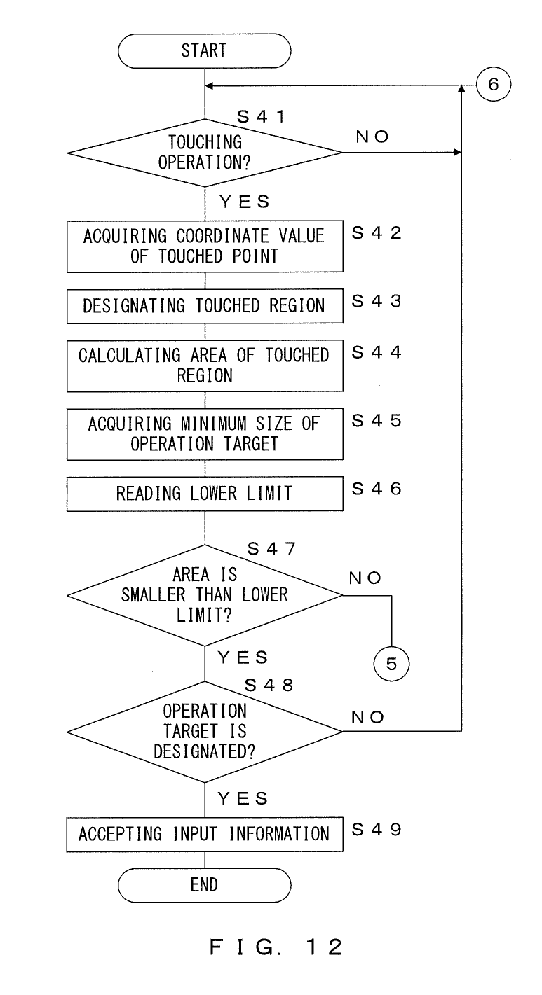

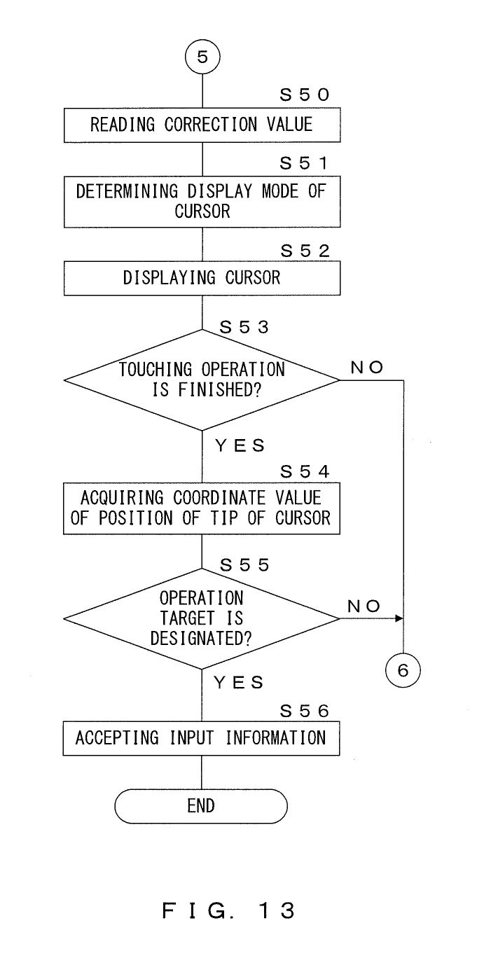

The process performed by the control unit 1 while a user is performing the touching operation in the electric equipment 10 according to the embodiment 3 is described below with reference to a flowchart. FIG. 12 and FIG. 13 are flowcharts of the procedure of the input information accepting process according to the embodiment 3. The following process is performed by the control unit 1 according to the control program stored in the ROM 2 or the storage unit 4 of the electric equipment 10.

The control unit 1 detects according to the detection signal from the touch sensor 61 whether or not the user has performed the touching operation on the touch panel 6 (S41). When the control unit 1 does not detects the touching operation (NO in S41), the process enters the standby state while performing other processes. When the control unit 1 detects the touching operation (YES in S41), the control unit 1 acquires the coordinate value of the touched point of the touching operation by the user (S42).

The control unit 1 designates the minimum rectangular touched region R0 including all touched points according to the acquired coordinate value of the touched point (S43). The control unit 1 calculates the area of the designated touched region R0 (S44). The control unit 1 acquires the minimum size of the operation target such as a button, a menu, etc. displayed on the touch panel 6 (S45), and reads the lower limit corresponding to the acquired minimum size from the lower limit DB 4b (S46).

The control unit 1 determines whether or not the area calculated in step S44 is smaller than the lower limit read from the lower limit DB 4b (S47). When it is determined that the calculated area is smaller than the lower limit (YES in S47), the control unit 1 tries to designate an operation target corresponding to the touched region R0 designated in step S43, and determines whether or not the corresponding operation target has been designated (S48). For example, the control unit 1 tries to designate an operation target including the touched region R0 in the display area of the operation target, and determines whether or not the operation target has been successfully designated.

When the control unit 1 determines that no operation target has been designated (NO in S48), control is returned to step S41. When it is determined that an operation target has been designated (YES in S48), the control unit 1 accepts the input information corresponding to the designated operation target, and terminates the process.

When the control unit 1 determines that the area calculated in step S44 is equal to or exceeds the lower limit (NO in S47), it reads the correction value corresponding to the calculated area from the correction value DB 4a (S50). The control unit 1 determines the display mode of the cursor C to be displayed on the touch panel 6 based on the shape of the touched region R0 designated in step S43 and the correction value read from the correction value DB 4a (S51). For example, the control unit 1 calculates the coordinate value of the center of the upper long side of the touched region R0 and the coordinate value of the position at a distance of the correction value read from the correction value DB 4a in the direction perpendicular to the upper long side from the center of the upper long side of the touched region R0.

The control unit 1 outputs to the display unit 60 a display instruction for display of the cursor C in the display mode determined in step S51, and displays the cursor C on the display unit 60 (S52). The control unit 1 monitors according to the detection signal from the touch sensor 61 whether or not the user touching operation has been finished (S53). If it is not detected that the touching operation has been finished (NO in S53), control is returned to step S41.

The control unit 1 repeats the processes in steps S41 through S52 until it is detected that the touching operation has been finished. When it is detected that the touching operation has been finished (YES in S53), the control unit 1 acquires the coordinate value of the position of the tip of the cursor C displayed at this timing (S54). The control unit 1 tries to designate an operation target corresponding to the acquired position of the tip of the cursor C, and determines whether or not the corresponding operation target has been designated (S55). For example, the control unit 1 tries to designate an operation target including the position of the tip of the cursor C in the display area of the operation target, and determines whether or not the operation target has been designated.

The control unit 1 returns control to step S41 when it is determined that the operation target cannot be designated (NO in step S55). When it is determined that the operation target is designated (YES in S55), the control unit 1 accepts the input information corresponding to the designated operation target (S56), and terminates the process.

As described above, according to the embodiment 3, the determination standards, as to whether the cursor is to be displayed or the operation target corresponding to the touched region is to be used as input information without displaying the cursor when the user performs the touching operation, are dynamically set. That is, the minimum size of the operation target (button and menu) displayed on the touch panel 6 is detected, and the minimum value of the area of the touched region as the reference of whether or not the cursor is to be displayed is changed depending on the detected minimum size.

For example, on the screen having a large display size for an operation target, there is no problem if an operation target corresponding to the touched point is selected although the touched region is relatively large when a user performs the touching operation because, on the screen having a large display size for an operation target, there is the possibility that the operation target corresponding to the touched point can be designated as a single target. However, on the screen having a small display size for an operation target, in a case where the touched region is large when a user performs the touching operation, there is the possibility that the touched region covers a plurality of operation targets, and the operation target corresponding to the touched region may not be designated as a single operation target.

Therefore, the input information corresponding to an operation target can be efficiently acquired on the screen having a large display size for an operation target by changing the determination standards as to whether or not the cursor is to be displayed depending on the display size of the operation target. On the screen having a small display size for an operation target, the input information corresponding to an operation target can be efficiently acquired, and the operability of the inputting operation is improved by displaying the cursor.

The embodiment 3 is described as an example of a variation of the embodiment 1, but can also be applied to the configuration of the embodiment 2.

### Embodiment 4

Described below is the electric equipment according to the embodiment 4. Since the electric equipment according to the embodiment 4 can be realized by the configuration similar to the electric equipment 10 according to the embodiment 1, the same or similar element is assigned the same reference numeral, and the detailed description is omitted here.

In the embodiment 1, the distance from the touched region when the user performs the touching operation to the position of the tip of the cursor is changed depending on the area of the touched region. The electric equipment 10 according to the embodiment 4 changes the distance from the touched region when the user performs the touching operation to the position of the tip of the cursor depending on the area of the touched region and the pushing pressure (operation state) when the user performs the touching operation.

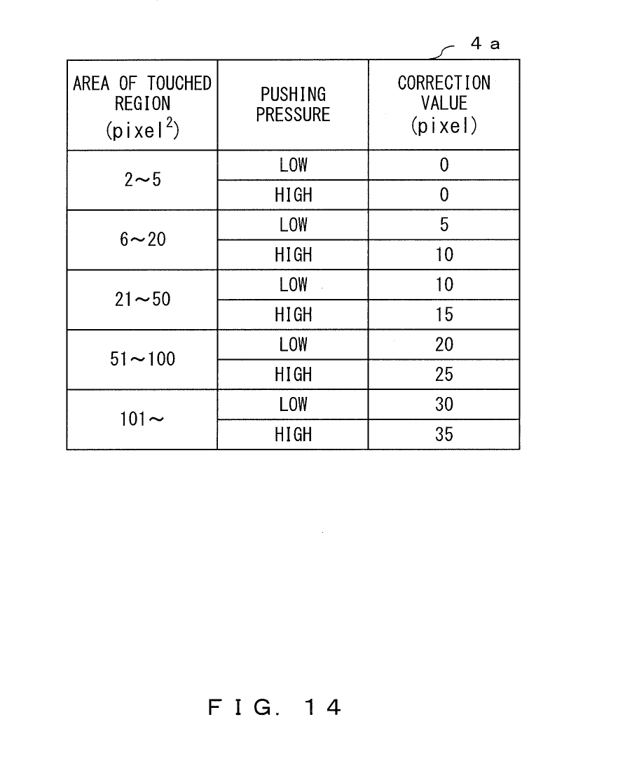

The electric equipment 10 according to the embodiment 4 includes hardware components illustrated in FIG. 1. The storage unit 4 according to the embodiment 4 stores the correction value DB 4a as illustrated in FIG. 14. FIG. 14 is a schematic diagram of the stored contents of the correction value DB 4a according to the embodiment 4. As illustrated in FIG. 14, the correction value DB 4a according to the embodiment 4 stores a correction value associated with the area of the touched region and the pushing pressure. The pushing pressure is the pressure detected by the touch sensor 61 when the user performs the touching operation, and a value smaller than a specified value is defined as “low” and a value equal to or exceeding the specified value is defined as “high” in the correction value DB 4a. The specified value may be appropriately changed with the accuracy etc. of the touch sensor 61 taken into account.

The correction value DB 4a stores in advance the optimum correction value corresponding to combination of the area of each touched region and the pushing pressure. In the correction value DB 4a in FIG. 14, an appropriate range is set as a value indicating the area of the touched region, but a correction value may also be set for each pixel². Also in the correction value DB 4a illustrated in FIG. 14, two levels “low” and “high” are set as the information about the pushing pressure, but the pushing pressure may also be classified into three or more levels, and a correction value may be set for each level. Furthermore, an equation for calculating the correction value depending on the area of a touched region and the pushing pressure may be set in advance, and the control unit 1 may calculate the correction value depending on the area of the touched region and the pushing pressure by using the equation.

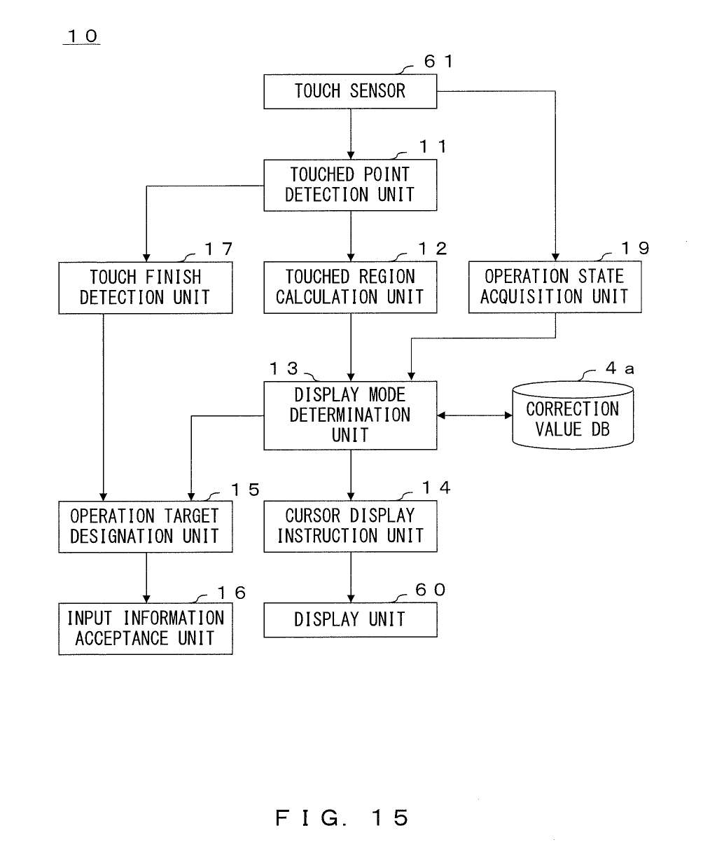

FIG. 15 is a functional block diagram of the electric equipment according to the embodiment 4. In the electric equipment 10 according to the embodiment 4, the control unit 1 can realize the function of the operation state acquisition unit 19 in addition to each function illustrated in FIG. 3 by executing the control program stored in the ROM 2 or the storage unit 4.

An operation state acquisition unit 19 acquires a detection signal output from the touch sensor 61. If the touch sensor 61 can detect pressure with accuracy, the operation state acquisition unit 19 detects the pushing pressure when a user performs the touching operation according to the detection signal from the touch sensor 61. Then, the operation state acquisition unit 19 determines whether or not the detected pushing pressure is equal to or exceeds a specified value, and notifies the display mode determination unit 13 of the determination result (high or low). If the touch sensor 61 cannot detect pressure with accuracy, the operation state acquisition unit 19 determines based on the value indicated by the detection signal from the touch sensor 61 whether or not the pushing pressure is equal to or exceeds a specified value when the user performs the touching operation. Then, the operation state acquisition unit 19 notifies the display mode determination unit 13 of the determination result (high or low).

As with the display mode determination unit 13 according to the embodiment 1, the display mode determination unit 13 according to the embodiment 4 acquires the shape and the area of the touched region R0 calculated by the touched region calculation unit 12. The display mode determination unit 13 according to the embodiment 4 also acquires from the operation state acquisition unit 19 a determination result indicating whether or not the pressure is equal to or exceeds a specified value when the user performs the touching operation.

The display mode determination unit 13 according to the embodiment 4 determines whether or not the area of the touched region R0 acquired from the touched region calculation unit 12 is smaller than the minimum value of the area of the touched region stored in the correction value DB 4a. When the display mode determination unit 13 determines that the acquired area is smaller than the minimum value, it notifies the operation target designation unit 15 of the coordinate value of the touched point notified from the touched region calculation unit 12 as the shape of the touched region R0.

When the display mode determination unit 13 determines that the acquired area is equal to or exceeds the minimum value, then the display mode determination unit 13 reads from the correction value DB 4a the correction value depending on the acquired area of the touched region R0 and the determination result notified from the operation state acquisition unit 19. Next, the display mode determination unit 13 calculates the coordinate value of the center of the upper long side of the touched region R0 based on the shape of the touched region R0 notified from the touched region calculation unit 12. The display mode determination unit 13 calculates the coordinate value of the position at a distance of the correction value read from the correction value DB 4a in the direction perpendicular to the upper long side from the center of the upper long side of the touched region R0. The position at a distance of the correction value from the center of the upper long side of the touched region R0 is defined as the position of the tip of the arrow-shaped cursor.

The display mode determination unit 13 notifies the cursor display instruction unit 14 of the coordinate value of the position of the tip of the cursor and the coordinate value of the center of the upper long side of the touched region R0. The direction of the line connecting the position of the tip of the cursor and the center of the upper long side of the touched region R0 is defined as the direction to be indicated by the cursor. In addition, the display mode determination unit 13 notifies the operation target designation unit 15 of the coordinate value of the position of the tip of the cursor.

Each component of the embodiment 4 other than the display mode determination unit 13 and the operation state acquisition unit 19 performs processes similar to the embodiment 1.

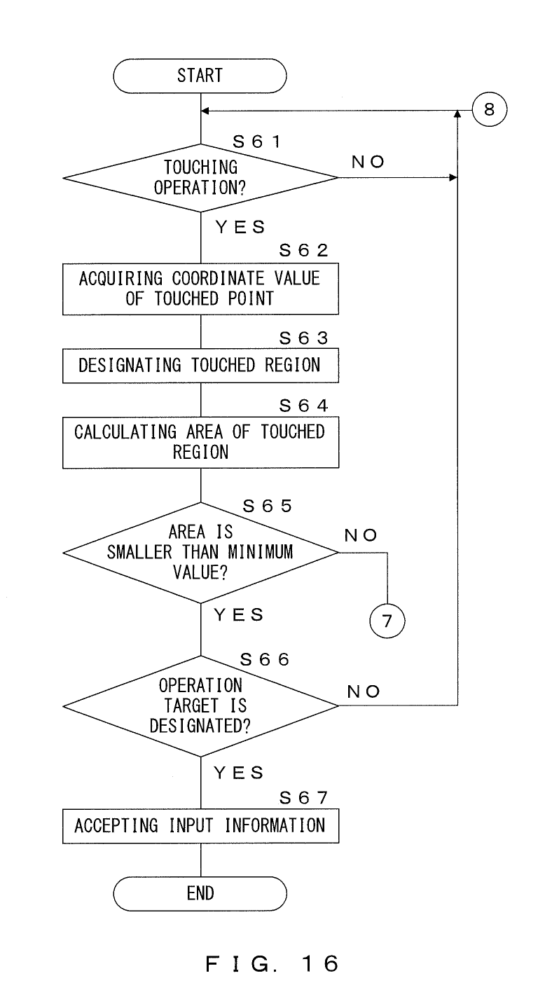

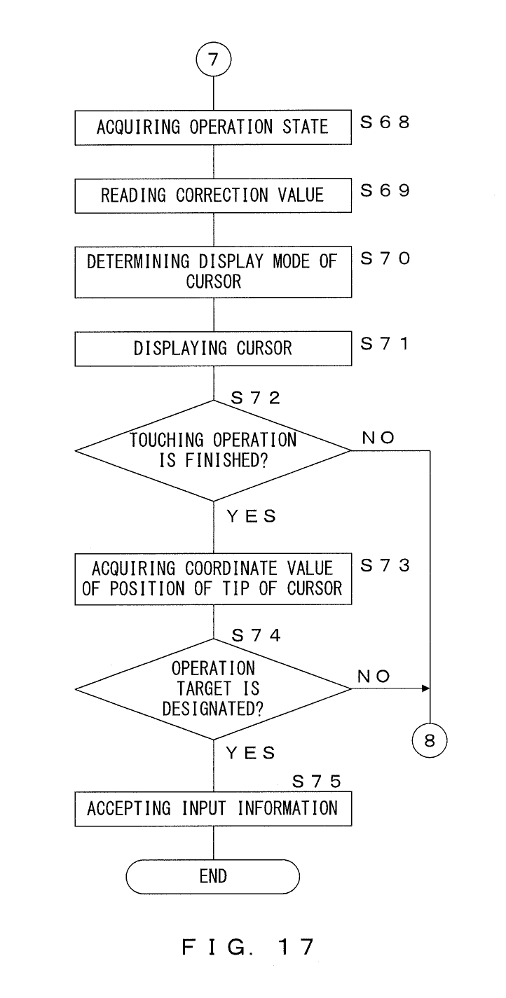

The process performed by the control unit 1 when a user performs the touching operation in the electric equipment 10 according to the embodiment 4 is described below with reference to a flowchart. FIG. 16 and FIG. 17 are flowcharts of the procedure of the input information accepting process according to the embodiment 4. The following process is performed by the control unit 1 according to the control program stored in the ROM 2 or the storage unit 4 of the electric equipment 10.

The control unit 1 detects whether or not the user has performed the touching operation on the touch panel 6 according to the detection signal from the touch sensor 61 (S61). If the touching operation has not been detected (NO in S61), the process enters the standby state while performing other processes. If the touching operation has been detected (YES in S61), the control unit 1 acquires the coordinate value of the touched point on which the user performs the touching operation (S62).

The control unit 1 designates the minimum rectangular touched region R0 including all touched points based on the coordinate value of the acquired touched point (S63). The control unit 1 calculates the area of the touched region R0 (S64). The control unit 1 determines whether or not the calculated area is smaller than the minimum value of the area of the touched region stored in the correction value DB 4a (S65). When it is determined that the calculated area is smaller than the minimum value (YES in S65), the control unit 1 tries to designate an operation target corresponding to the touched region R0 designated in step S63, and determines whether or not the corresponding operation target is designated (S66). For example, the control unit 1 tries to designate an operation target including the touched region R0 in the display area of the operation target, and determines whether or not the operation target is successfully designated.

When the control unit 1 determines that the operation target cannot be designated (NO in S66), control is returned to step S61. When the control unit 1 determines that the operation target has been designated (YES in S66), then it accepts the input information corresponding to the designated operation target (S67), and the process terminates.

When it is determined that the area calculated in step S64 is equal to or exceeds the minimum value (NO in S66), the control unit 1 acquires the operation state of the electric equipment 10 (S68). In this case, the control unit 1 determines according to the detection signal from the touch sensor 61 whether or not the pushing pressure is equal to or exceeds a specified value when the user performs the touching operation. The control unit 1 reads from the correction value DB 4a the correction value depending on the area calculated in step S64 and the operation state acquired in step S68 (S69).

The control unit 1 determines the display mode of the cursor C to be displayed on the touch panel 6 based on the shape of the touched region R0 designated in step S63 and the correction value read from the correction value DB 4a (S70). For example, the control unit 1 calculates the coordinate value of the center of the upper long side of the touched region R0 and the coordinate value of the position at a distance of the correction value read from the correction value DB 4a in the direction perpendicular to the upper long side from the center of the upper long side of the touched region R0.

The control unit 1 outputs to the display unit 60 a display instruction for display of the cursor C in the display mode determined in step S70, and displays the cursor C on the display unit 60 (S71). The control unit 1 monitors whether or not the touching operation has been finished by the user (S72), and if the touching operation has not been finished (NO in S72), control is returned to step S61.

The control unit 1 repeats the processes in steps S61 through S71 until the termination of the touching operation is detected. When it is detected that the touching operation has been finished (YES in S72), the control unit 1 acquires the coordinate value of the position of the tip of the cursor C displayed at this time (S73). The control unit 1 tries to designate an operation target corresponding to the acquired position of the tip of the cursor C, and determines whether or not the corresponding operation target has been designated (S74). For example, the control unit 1 tries to designate an operation target including the position of the tip of the cursor C in the display area of the operation target, and determines whether or not the operation target has been designated.

When the control unit 1 determines that the operation target cannot be designated (NO in S74), control is returned to step S61. When the control unit 1 determines that the operation target has been designated (YES in S74), it accepts the input information corresponding to the designated operation target (S75), and terminates the process.

As described above, the electric equipment 10 according to the embodiment 4 can determine the operation state such as the area of the touched region, whether the pushing pressure is high or low, etc. when the user performs the touching operation. When the pushing pressure is high and the touched region is large, it is estimated that the touched region has become large by performing the touching operation with high pressure. Therefore, when the pushing pressure is high, the larger the area of the touched region, the larger correction value is set as a distance from the touched region to the position of the tip of the cursor, thereby displaying the cursor in an appropriate position.

As described above, according to the embodiment 4, in both of the cases that the pushing pressure is high and low, the larger the area of the touched region is, the larger value is set as a correction value which is the distance from the touched region to the position of the tip of the cursor in the correction value DB 4a. When the area of the touched region is the same, the higher the pushing pressure is, the larger value is set as a correction value. Thus, when the touched region is large, a cursor is displayed in the position at a certain distance from the finger of a user, thereby displaying the cursor in a visible position for the user.

The relationship between the area of the touched region and the pushing pressure, and the correction value is not limited to the example above. For example, when the pushing pressure is high, the larger the area of the touched region is, the smaller value may be assigned to the correction value. In this case, when the touching operation is performed with strong power, the larger the touched region is, the closer to the finger of the user the cursor is displayed, thereby easily performing the operation of the cursor.

When the area of the touched region is the same, the higher the pushing pressure is, the smaller value may be set. In this case, when the touching operation is performed with strong power, the closer to the finger of the user, the cursor is displayed, thereby easily performing the operation of the cursor.

The embodiment 4 is described above as a variation example of the embodiment 1, but it can be applied to the configuration of the embodiments 2 and 3, too.

### Embodiment 5

Described below is the electric equipment according to the embodiment 5. Since the electric equipment according to the embodiment 5 can be realized by the configuration similar to that of the electric equipment 10 according to the embodiments 1 and 4, the same or similar element is assigned the same reference numeral, and the detailed description is omitted here.

In the embodiment 4, the distance from the touched region when the user performs the touching operation to the position of the tip of the cursor is changed depending on the area of the touched region and the pushing pressure (operation state) when the user performs the touching operation. The electric equipment 10 according to the embodiment 5 detects the inclination of the electric equipment 10, and changes the distance from the touched region when the user performs the touching operation to the position of the tip of the cursor depending on the area of the touched region and the inclination (operation state) of the electric equipment 10 when the user performs the touching operation.

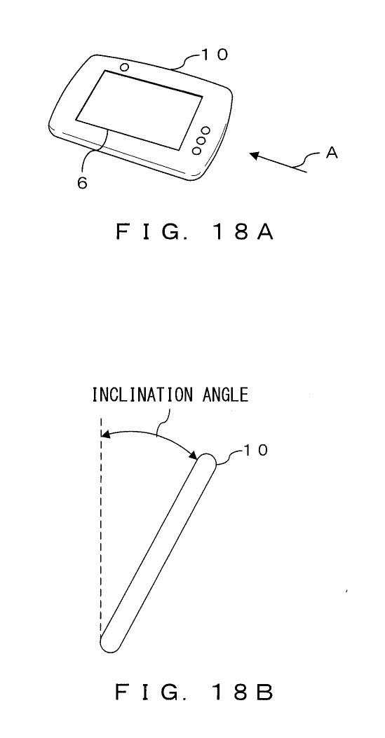

FIGS. 18A and 18B are schematic diagrams of the appearance of the electric equipment 10 according to the embodiment 5. FIG. 18A is a perspective view of the electric equipment 10, and FIG. 18B is a view from the direction of the arrow A illustrated in FIG. 18A. The electric equipment 10 according to the embodiment 5 is planar in form, and the touch panel 6 is provided at the center of one side. There is a strong possibility that the electric equipment 10 according to the embodiment 5 is inclined as illustrated in FIG. 18B when it is used by a user. Especially there is a strong possibility that the touch panel 6 is inclined in the diagonally upper direction.

Therefore, the electric equipment 10 according to the embodiment 5 detects the angle of inclination illustrated in FIG. 18B. Then, the electric equipment 10 changes the distance from the touched region when the user performs the touching operation to the position of the tip of the cursor depending on the area of the touched region and the detected angle of inclination.

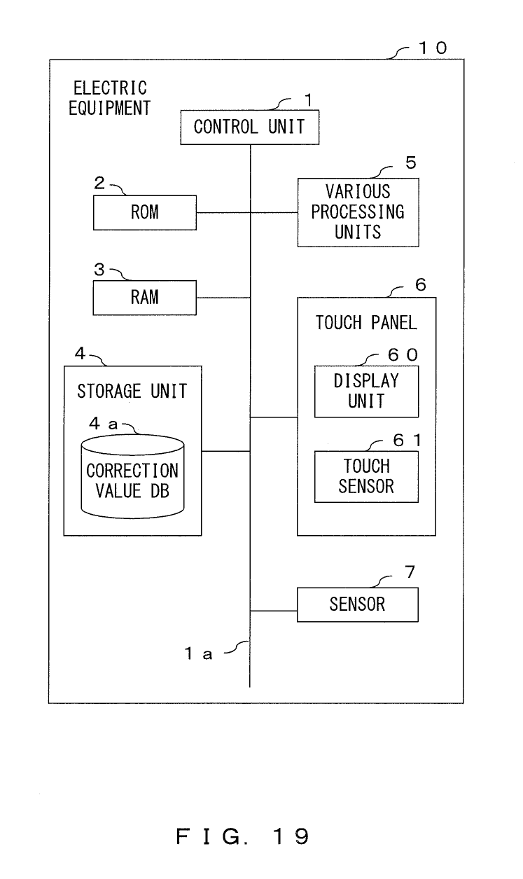

FIG. 19 is a block diagram of an example of the configuration of the electric equipment 10 according to the embodiment 5. The electric equipment 10 according to the embodiment 5 includes a sensor 7 in addition to the hardware components illustrated in FIG. 1. The sensor 7 according to the embodiment 5 is, for example, an acceleration sensor. The sensor 7 detects the acceleration of gravity applied to the electric equipment 10, and the angle of inclination of the electric equipment 10 illustrated in FIG. 18B is detected based on the detected acceleration of gravity.

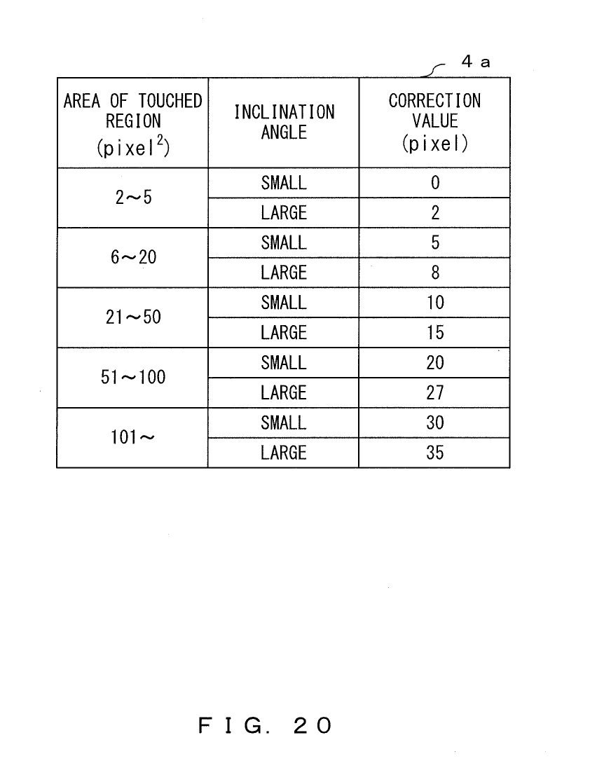

The storage unit 4 according to the embodiment 5 stores the correction value DB 4a as illustrated in FIG. 20. FIG. 20 is a schematic diagram of the stored contents of the correction value DB 4a according to the embodiment 5. As illustrated in FIG. 20, the correction value DB 4a according to the embodiment 5 stores a correction value associated with the area of the touched region and the angle of inclination. The angle of inclination is given to the electric equipment 10 as illustrated in FIG. 18B, and a value smaller than a specified value is stored as “small” and a value equal to or exceeding the specified value is stored as “large” in the correction value DB 4a. The specified value may be appropriately changed with the accuracy etc. of the sensor 7 taken into account.

The correction value DB 4a stores in advance the optimum correction value corresponding to the area of each touched region and the angle of inclination. In the correction value DB 4a in FIG. 20, an appropriate range is set as a value indicating the area of the touched region, but a correction value may also be set for each pixel². Also in the 4a illustrated in FIG. 20, two levels “small” and “large” are set as the information about the angle of inclination, but the angle of inclination may also be classified into three or more levels, and a correction value may be set for each level. Furthermore, an equation for calculating the correction value depending on the area of a touched region and the angle of inclination may be set in advance, and the control unit 1 may calculate the correction value depending on the area of the touched region and the angle of inclination by using the equation.

In the electric equipment 10 according to the embodiment 5, the control unit 1 realizes the function similar to each function illustrated in FIG. 15 by executing the control program stored in the ROM 2 or the storage unit 4. However, the operation state acquisition unit 19 according to the embodiment 5 acquires not the detection signal from the touch sensor 61, but the detection signal from the sensor 7. If the sensor 7 can detect the angle of inclination with accuracy, the operation state acquisition unit 19 detects the angle of inclination of the electric equipment 10 when the user performs the touching operation according to the detection signal from the sensor 7. The operation state acquisition unit 19 determines whether or not the detected angle of inclination is equal to or exceeds a specified value, and notifies the display mode determination unit 13 of the determination result (large or small).

If the sensor 7 cannot detect pressure with accuracy, the operation state acquisition unit 19 determines based on the value indicated by the detection signal from the sensor 7 whether or not the angle of inclination of the electric equipment 10 is equal to or exceeds a specified value when the user performs the touching operation. Then, the operation state acquisition unit 19 notifies the display mode determination unit 13 of the determination result (large or small).

As with the display mode determination unit 13 according to the embodiment 1, the display mode determination unit 13 according to the embodiment 5 acquires the shape and the area of the touched region R0 calculated by the touched region calculation unit 12. The display mode determination unit 13 according to the embodiment 5 also acquires from the operation state acquisition unit 19 a determination result indicating whether or not the angle of inclination of the electric equipment 10 is equal to or exceeds a specified value when the user performs the touching operation.

The display mode determination unit 13 according to the embodiment 5 determines whether or not the area of the touched region R0 acquired from the touched region calculation unit 12 is smaller than the minimum value of the area of the touched region stored in the correction value DB 4a. When the display mode determination unit 13 determines that the acquired area is smaller than the minimum value, it notifies the operation target designation unit 15 of the coordinate value of the touched point notified from the touched region calculation unit 12 as the shape of the touched region R0.

When the display mode determination unit 13 determines that the acquired area is equal to or exceeds the minimum value, then the display mode determination unit 13 reads from the correction value DB 4a the correction value depending on the acquired area of the touched region R0 and the determination result notified from the operation state acquisition unit 19. Next, the display mode determination unit 13 calculates the coordinate value of the center of the upper long side of the touched region R0 based on the shape of the touched region R0 notified from the touched region calculation unit 12. The display mode determination unit 13 calculates the coordinate value of the position at a distance of the correction value read from the correction value DB 4a in the direction perpendicular to the upper long side from the center of the upper long side of the touched region R0. The position at a distance of the correction value from the center of the upper long side of the touched region R0 is defined as the position of the tip of the arrow-shaped cursor.

The display mode determination unit 13 notifies the cursor display instruction unit 14 of the coordinate value of the position of the tip of the cursor and the coordinate value of the center of the upper long side of the touched region R0. The direction of the line connecting the position of the tip of the cursor and the center of the upper long side of the touched region R0 is defined as the direction to be indicated by the cursor. In addition, the display mode determination unit 13 notifies the operation target designation unit 15 of the coordinate value of the position of the tip of the cursor.

Each component of the embodiment 5 other than the display mode determination unit 13 and the operation state acquisition unit 19 performs processes similar to the embodiments 1 and 4.

In the electric equipment 10 according to the embodiment 5, the process performed by the control unit 1 when the user performs the touching operation is similar to the input information accepting process according to the embodiment 4 illustrated in FIG. 16 and FIG. 17. Therefore, the detailed description is omitted here.

Note that the control unit 1 according to the embodiment 5 determines in step S68 in FIG. 17 whether or not the angle of inclination of the electric equipment 10 is equal to or exceeds a specified value according to the detection signal from the sensor 7 when the user performs the touching operation.

As described above, the electric equipment 10 according to the embodiment 5 can determine the operation state including the area of the touched region and whether the angle of inclination of the electric equipment 10 is large or small when the user performs the touching operation. Thus, by detecting the angle of inclination of the electric equipment 10, the level of the influence generated depending on the angle of inclination can be determined.

As described above, according to the embodiment 5, in both of cases that the angle of inclination is large and small, the larger the area of the touched region is, the larger value is set as a correction value which is the distance from the touched region to the position of the tip of the cursor in the correction value DB 4a. When the area of the touched region is the same, the larger the angle of inclination is, the larger value is set as the correction value. Thus, when the angle of inclination is large, a cursor is displayed in the position at a certain distance from the finger of a user, thereby displaying a cursor at an appropriate position. For example, the cursor can be prevented from being hidden by the finger of a user.

However, the relationship between the area of the touched region, the angle of inclination, and the correction value is not limited to this example. For example, when the angle of inclination is large, the larger the area of the touched region is, the smaller value may be set as the correction value. In addition, when the area of the touched region is the same, the larger the angle of inclination is, the smaller value may be set as the correction value.

In the embodiment 5, the angle at which the upper side of the electric equipment 10 is inclined to the reverse of the surface on which the touch panel 6 is provided is used as the angle of inclination given to the electric equipment 10. However, the angle is not limited to the example illustrated in FIG. 18B, but may be the angle at which it is inclined with respect to the electric equipment 10, the angle at which it is rotated using the diagonal line of the rectangular touch panel 6 as an axis, etc. For example, an angle which can be measured using a 3D motion sensor including a gyro sensor, an acceleration sensor, etc. may be used.

In the embodiment 4, the pushing pressure detected by the touch sensor 61 is used as an operation state of the electric equipment 10. In the embodiment 5, the angle of inclination detected by the sensor 7 is used as an operation state of the electric equipment 10. However, the operation state of the electric equipment 10 is not limited to the information, and the sensor for detecting the information is not limited to these sensors.

The sensor for detecting the operation state is, for example, a proximity sensor for detecting the distance between the electric equipment 10 and the user, a temperature sensor for detecting the temperature of the surface of the touch panel 6, an illumination sensor for detecting the illumination of the surface of the touch panel 6, etc. In addition, an image of the surface of the touch panel 6 is shot, and the obtained image data is image-processed, thereby utilizing the image sensor for detecting various states in the electric equipment 10. It is obvious that sensors other than the above-mentioned sensors may be used, and any combination of these sensors may be used.

### Embodiment 6

Described below is the electric equipment according to the embodiment 6. Since the electric equipment according to the embodiment 6 can be realized by the configuration similar to that of the control system according to the embodiment 1, the same or similar element is assigned the same reference numeral, and the detailed description is omitted here.

In the embodiments 1 through 5, the touched region when the user performs the touching operation is the area including all touched points. The electric equipment 10 according to the embodiment 6 performs the clustering process on the touched points when the user performs the touching operation, thereby classifying into a plurality of areas (clusters), and obtaining a touched region among the classified areas.

The electric equipment 10 according to the embodiment 6 includes the hardware components illustrated in FIG. 1.

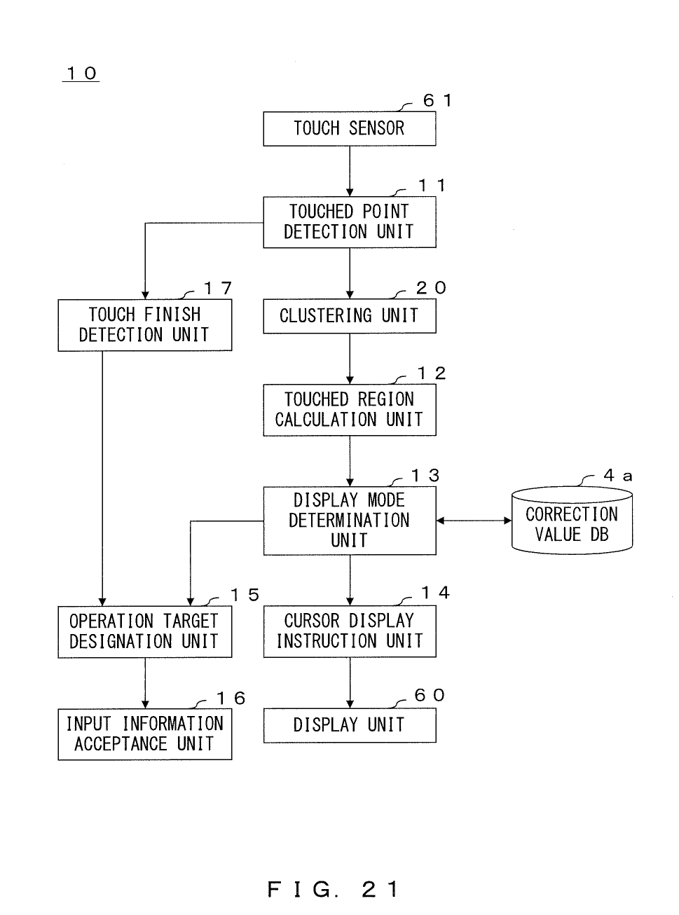

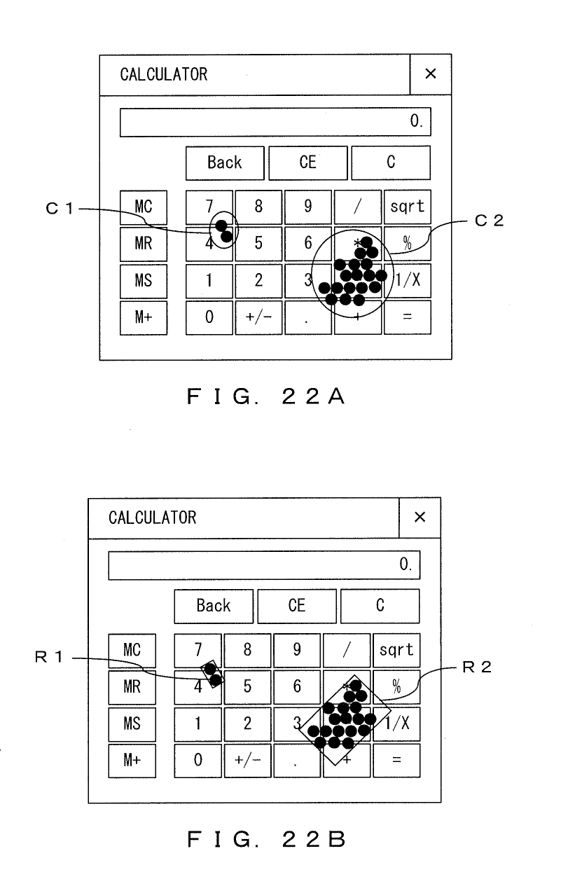

FIG. 21 is a functional block diagram of the electric equipment 10 according to the embodiment 6. FIGS. 22A and 22B are schematic diagrams for explanation of the clustering process. FIGS. 22A and 22B illustrate, as with FIGS. 4A and 4B, an example of the screen displayed on the touch panel 6 when the calculator software is executed on the electric equipment 10. The black dots in FIGS. 22A and 22B schematically indicate touched points where the user touches the touch panel 6. FIGS. 22A and 22B illustrate the state in which the user touches the touch panel 6 by the palm of his or her hand when the user performs the touching operation with the finger tip or a pen, C1 and R1 represents the touched regions with the finger tip or a pen, and C2 and R2 represent the touched regions of the palm of the hand of the user.

In the electric equipment 10 according to the embodiment 6, the control unit realizes the function of the clustering unit 20 in addition to each function illustrated in FIG. 3 by executing the control program stored in the ROM 2 or storage unit 4.

The touched point detection unit 11 according to the embodiment 6 acquires, as with the touched point detection unit 11 according to the embodiment 1, the coordinate value of the touched point on which the user performs the touching operation according to the detection signal from the touch sensor 61. In the state illustrated in FIG. 22A, the touched point detection unit 11 acquires the coordinate value of each touched point indicated by the black dots in FIG. 22A. The touched point detection unit 11 transmits to the touch finish detection unit 17 and the clustering unit 20 the coordinate values of all detected touched points.

The clustering unit 20 acquires the coordinate values of all touched points from the touched point detection unit 11. The clustering unit 20 performs the clustering process on the acquired coordinate values of each touched point using the algorithm of a K-means method, a Ward's method, etc. The clustering unit 20 classifies each touched point into a plurality of clusters, and transmits the coordinate value of each touched point to the touched region calculation unit 12 for each classified cluster.

In the state in FIG. 22A, the clustering unit 20 classifies each touched point into two clusters C1 and C2. The algorithm of the clustering process is not limited to the K-means method and the Ward's method. The clustering unit 20 may use other algorithm capable of classifying each touched point according to a specified condition as to whether or not each touched point is adjacent to each other closer than a threshold distance.

The touched region calculation unit 12 according to the embodiment 6 acquires the coordinate value of each touched point for each cluster classified by the clustering unit 20. The touched region calculation unit 12 according to the embodiment 6 designates a rectangular (touched region) of the minimum size including each touched point based on the coordinate value of each touched point for each cluster. The touched region calculation unit 12 calculates the area of the designated touched region for each cluster.

In the example in FIG. 22B, the touched region calculation unit 12 designates the touched regions R1 and R2 corresponding to each cluster, and calculates the area of the designated touched regions R1 and R2, respectively. The touched region calculation unit 12 designates a smaller touched region R1 (or R2) in the areas of the calculated touched regions R1 and R2. The touched region calculation unit 12 notifies the display mode determination unit 13 of the shape and the area of the designated touched region R1 (or R2). Thus, the touched point included in the touched region R1 (or R2) having a larger area is deleted as a touched point not necessary in the touching operation. Therefore, for example, when the palm of the hand touches the touch panel 6 during the touching operation, the influence of unintended touch (such as with the palm) is removed and the cursor can be displayed in an appropriate position.

The shape of the touched region R1 (or R2) is notified using the coordinate value of each vertex of the touched region R1 (or R2). When only one touched point is included in the designated touched region R1 (or R2), the touched region calculation unit 12 notifies the display mode determination unit 13 of the coordinate value of the touched point included in the designated touched region R1 (or R2) as the shape of the touched region R1 (or R2).

Each component other than the touched point detection unit 11, the touched region calculation unit 12, and the clustering unit 20 according to the embodiment 6 performs process similar to the embodiment 1.

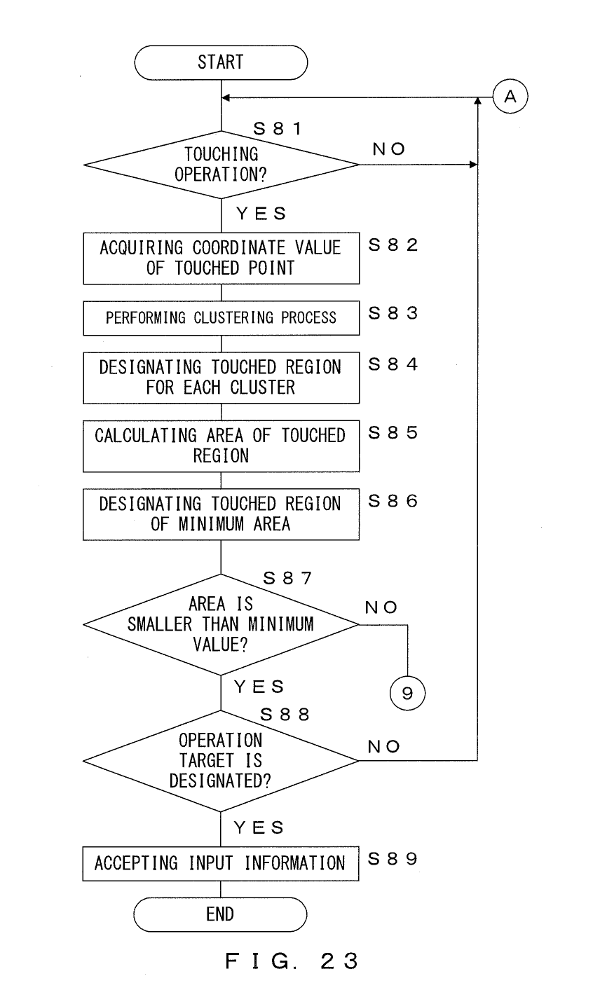

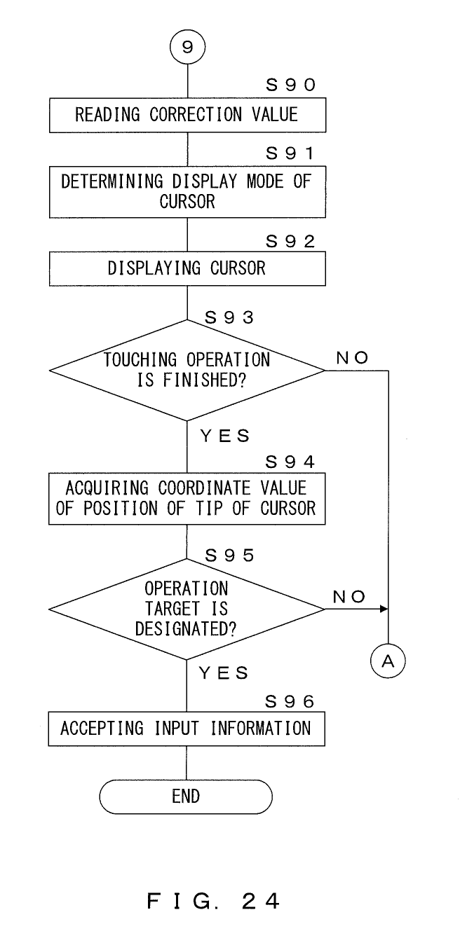

The process performed by the control unit 1 when the user performs the touching operation in the electric equipment 10 according to the embodiment 6 is described below with reference to a flowchart. FIG. 23 and FIG. 24 are flowcharts of the procedure of the input information accepting process according to the embodiment 6. The following process is performed by the control unit 1 according to the control program stored in the ROM 2 or the storage unit 4.

The control unit 1 detects whether or not the touch panel 6 is touched by a user according to the detection signal from the touch sensor 61 (S81). If it is not detected that the touching operation has been performed (NO in S81), a standby state is entered while performing other processes. If the touching operation has been detected (YES in S81), then the control unit 1 acquires the coordinate value of the touched point on which the user performs the touching operation (S82).

The control unit 1 performs the clustering process on the acquired coordinate values of the touched points (S83), and classifies touched points into a plurality of clusters. The control unit 1 designates rectangular touched regions R1 and R2 of the smallest size and including all touched points classified into a corresponding cluster (S84). The control unit 1 calculates the areas of the designated touched regions R1 and R2, respectively (S85). The control unit 1 designates the touched region R1 (or R2) of the smallest area in the calculated areas of the touched regions R1 and R2 (S86).

The control unit 1 determines whether or not the area of the designated touched region R1 (or R2) is smaller than the minimum value of the area of the touched region stored in the correction value DB 4a (S87). When it is determined that the area of the designated touched region R1 (or R2) is smaller than the minimum value (YES in S87), the control unit 1 tries to designate an operation target corresponding to the touched region R1 (or R2) designated in step S86, and determines whether or not the corresponding operation target has been designated (S88). For example, the control unit 1 tries to designate an operation target including the touched region R1 (or R2) in the display area of the operation target, and determines whether or not the operation target has been successfully designated.

When the control unit 1 determines that the operation target has not been designated (NO in S88), control is returned to step S81. When the control unit 1 determines that the operation target has been designated (YES in S88), the control unit 1 accepts the input information corresponding to the designated operation target (S89), thereby terminating the process.

When the control unit 1 determines that the area of the touched region R1 (or R2) designated in step S86 is equal to or exceeds the minimum value (NO in S87), it reads a correction value corresponding to the area of the touched region R1 (or R2) from the correction value DB 4a (S90). The control unit 1 determines the display mode of the cursor C to be displayed on the touch panel 6 based on the shape of the touched region R1 (or R2) designated in step S86 and the correction value read from the correction value DB 4a (S91). For example, the control unit 1 calculates the coordinate value of the center of the upper long side of the touched region R1 (or R2) and the coordinate value of the position at a distance of the correction value read from the correction value DB 4a in the direction perpendicular to the upper long side from the center of the upper long side of the touched region R1 (or R2).

The control unit 1 outputs to the display unit 60 a display instruction for display of the cursor C in the display mode determined in step S91, and displays the cursor C on the display unit 60 (S92). The control unit 1 monitors according to the detection signal from the touch sensor 61 whether or not the user touching operation has been finished (S93). If the touching operation has not been finished (NO in S93), control is returned to step S81.

The control unit 1 repeats the processes in steps S81 through S92 until it is detected that the touching operation has been finished. When it is detected that the touching operation has been finished (YES in S93), the control unit 1 acquires the coordinate value of the position of the tip of the cursor C displayed at this timing (S94). The control unit 1 tries to designate an operation target corresponding to the acquired position of the tip of the cursor C, and determines whether or not the corresponding operation target has been designated (S95). For example, the control unit 1 tries to designate an operation target including the position of the tip of the cursor C in the display area of the operation target, and determines whether or not the operation target has been designated.

The control unit 1 returns control to step S81 when it is determined that the operation target cannot be designated (NO in S95). When it is determined that the operation target can be determined (YES in S95), the control unit 1 accepts the input information corresponding to the designated operation target (S96), and terminates the process.

As described above, the touched point when the user performs the touching operation is classified into a plurality of clusters in the clustering process according to the embodiment 6, and a cluster including a touched point intended by a user is designated from among the classified clusters. Thus, the touched points unnecessary for the touching operation are removed, thereby improving the determination accuracy of an operation target in the touching operation.

In the embodiment 6, the touched region is detected for each cluster by the clustering unit 20, and a touched region having the smallest area is defined as a necessary touched region for the touching operation. However, for example, a touched region having a large area in each designated touched region may be defined as a necessary touched region for the touching operation. In this case, for example, when fine dust is attached to the touch panel 6, the point where the dust is attached is not defined as a necessary touched region for the touching operation, thereby improving the accuracy of the touching operation.

The embodiment 6 is described above as a variation example of the embodiment 1, but it may also be applied to the configuration according to the embodiments 2 through 5.

### Embodiment 7

Described below is the electric equipment according to the embodiment 7. Since the electric equipment according to the embodiment 7 can be realized by the configuration similar to the electric equipment 10 according to the embodiment 1, the same or similar element is assigned the same reference numeral, and the detailed description is omitted here.

The electric equipment 10 according to the embodiment 7 performs the similar processes as with the electric equipment 10 according to the embodiment 1, and also performs an updating process to update the correction value DB 4a.

The electric equipment 10 according to the embodiment 7 includes hardware components illustrated in FIG. 1.

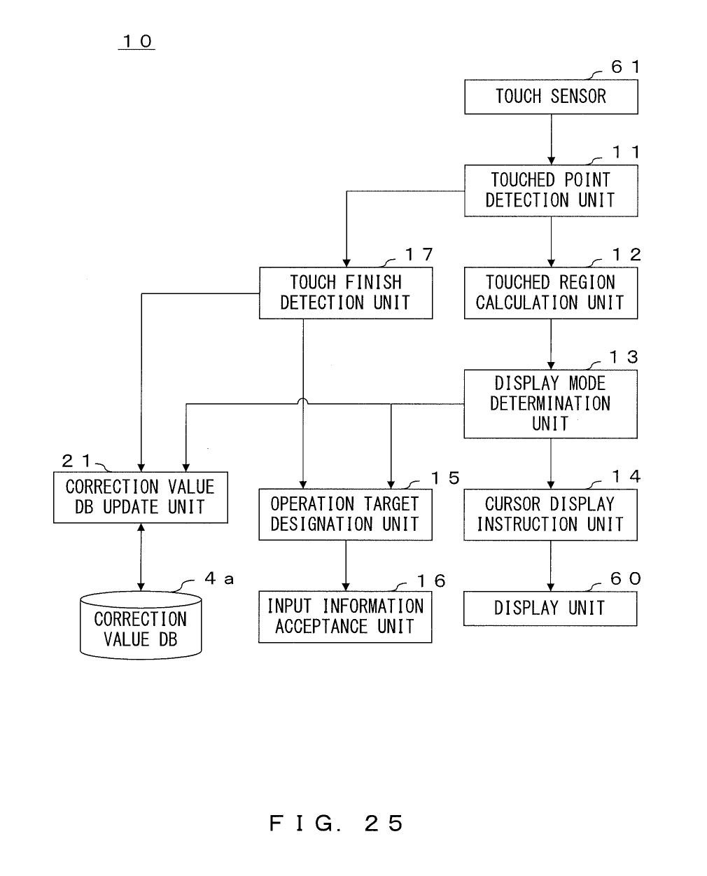

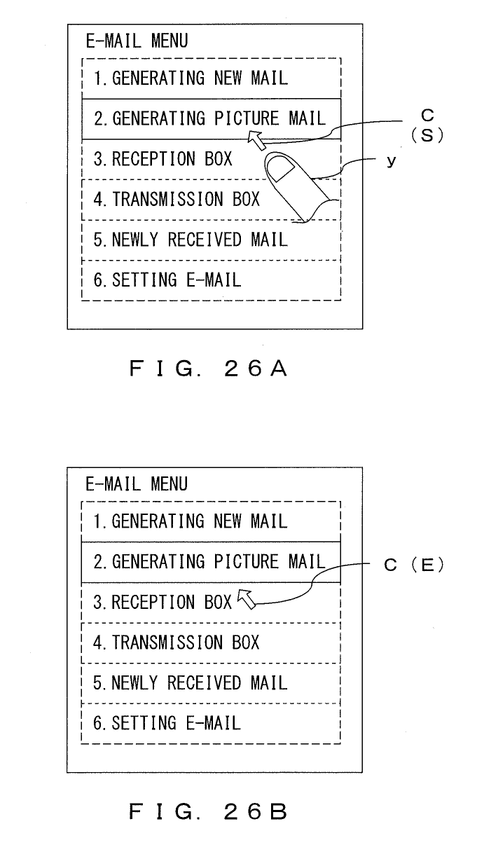

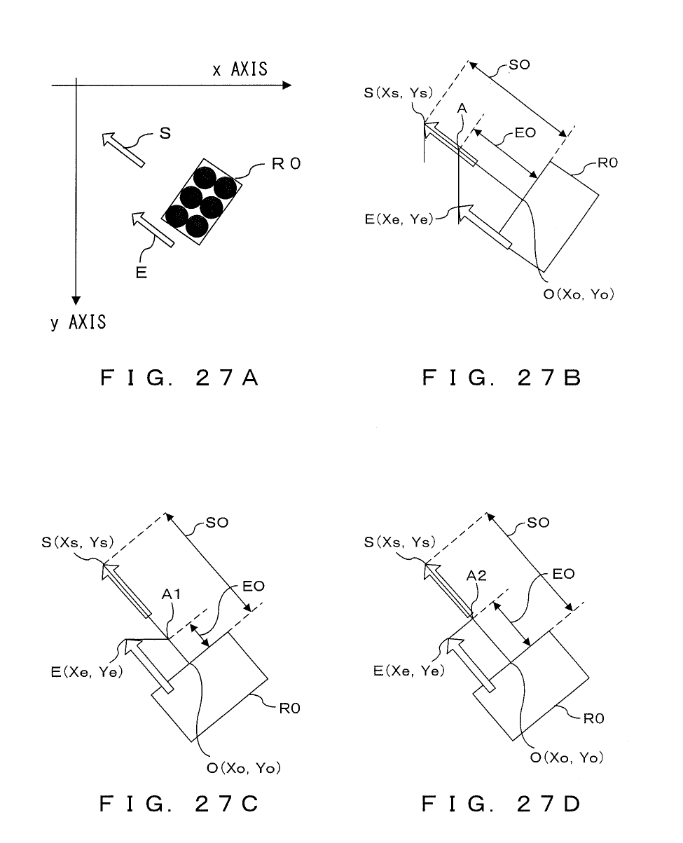

FIG. 25 is a functional block diagram of the electric equipment 10 according to the embodiment 7. FIG. 26 and FIG. 27 are schematic diagrams for explanation of an updating process of the correction value DB 4a. FIGS. 26A and 26B illustrate an example of a screen displayed on the touch panel 6 when a mailer is executed on the electric equipment 10.

FIG. 26A illustrates an example of the screen when the user starts the touching operation, and FIG. 26B is the example of the screen displayed immediately after the user finishes the touching operation. That is, when the user starts the touching operation, the cursor C (cursor S) is displayed in the position as illustrated in FIG. 26A, and when the user finishes the touching operation, the cursor C (cursor E) is displayed in the position illustrated in FIG. 26B. FIG. 27A-27D illustrate the extracted views of the cursor S when the touching operation is started and the cursor E when the touching operation is finished as illustrated in FIGS. 26A and 26B, and the touched region R0 when the touching operation is started.

In the electric equipment 10 according to the embodiment 7, the control unit 1 realizes the function of a correction value DB update unit 21 in addition to each function illustrated in FIG. 3.

The display mode determination unit 13 according to the embodiment 7 acquires from the touched region calculation unit 12, as with the display mode determination unit 13 according to the embodiment 1, the shape and the area of the touched region R0 when the user performs the touching operation. The display mode determination unit 13 according to the embodiment 7 determines whether or not the acquired area of the touched region R0 is smaller than the minimum value of the area of the touched region stored in the correction value DB 4a. When it is determined that the acquired area is smaller than the minimum value, the display mode determination unit 13 notifies the operation target designation unit 15 of the coordinate value of the touched point notified from the touched region calculation unit 12 as the shape of the touched region R0.

When the display mode determination unit 13 determines that the acquired area is equal to or exceeds the minimum value, then it reads the correction value depending on the acquired area of the touched region R0 from the correction value DB 4a. The display mode determination unit 13 calculates the coordinate value of the center of the upper long side of the touched region R0 based on the shape of the touched region R0 notified from the touched region calculation unit 12. The display mode determination unit 13 calculates the coordinate value of the position at the distance of the correction value read from the correction value DE 4a from the center of the upper long side of the touched region R0 in the direction perpendicular to the upper long side. The position at the distance of the correction value from the center of the upper long side of the touched region R0 is defined as the position of the tip of the arrow shaped cursor.

The display mode determination unit 13 notifies the cursor display instruction unit 14 of the coordinate value of the position of the tip of the cursor and the coordinate value of the center of the upper long side of the touched region R0. The direction connecting the position of the tip of the cursor and the center of the upper long side of the touched region R0 is defined as the direction to be indicated by the cursor. The display mode determination unit 13 notifies the operation target designation unit 15 of the coordinate value of the position of the tip of the cursor.

The display mode determination unit 13 according to the embodiment 7 notifies the correction value DB update unit 21 of the coordinate value of the center of the upper long side of the touched region R0 calculated based on the shape of the touched region R0 notified from the touched region calculation unit 12. The display mode determination unit 13 according to the embodiment 7 notifies the correction value DB update unit 21 of the sequentially calculated coordinate value of the position of the tip of the cursor. Note that the center of the upper long side of the touched region R0 is defined as the reference point of the touched region R0.

The touch finish detection unit 17 according to the embodiment 7 determines whether or not the touching operation by the user has been finished based on the coordinate value of the touching operation acquired from the touched point detection unit 11. When the touch finish detection unit 17 detects that the touching operation by the user has been finished, it notifies the operation target designation unit 15 and the correction value DB update unit 21 that the touching operation has been finished.

The correction value DB update unit 21 acquires from the display mode determination unit 13 the coordinate value of the center (reference point of the touched region R0) of the upper long side of the touched region R0 and the coordinate value of the position of the tip of the cursor when the user performs the touching operation. In addition, when the touching operation performed by the user is finished, the correction value DB update unit 21 is notified of the termination of the touching operation from the touch finish detection unit 17.

The correction value DB update unit 21 acquires the coordinate value of the reference point of the touched region R0 and the coordinate value of the position of the tip of the cursor S when the user starts the touching operation from the display mode determination unit 13. The reference point of the touched region R0 when the user starts the touching operation is the point O (Xo, Yo) in FIG. 27B-27D, and the position of the tip of the cursor S when the user starts the touching operation is the point S (Xs, Ys) in FIG. 27B-27D.

The correction value DB update unit 21 acquires the coordinate value of the position of the tip of the cursor E when the user finishes the touching operation from the display mode determination unit 13 based on the timing of the notification of the termination of the touching operation from the touch finish detection unit 17. The position of the tip of the cursor E at the termination of the touching operation by the user is the point E (Xe, Ye) in FIG. 27B-27D.

The correction value DB update unit 21 calculates the amount of movement from the cursor S to the cursor E based on the reference point O (Xo, Yo) of the touched region R0, the position S (Xs, Ys) of the tip of the cursor S, and the position E (Xe, Ye) of the tip of the cursor E. The correction value DB update unit 21 calculates, for example, the intersection point A (X, Y) of the line SO and x=Xe as illustrated in FIG. 27B. Then, the correction value DB update unit 21 calculates the length of the line SA and defines the calculated length as the amount of movement.

The method of calculating the amount of movement is not limited to the example illustrated in FIG. 27B. For example, as illustrated in FIG. 27C, the correction value DB update unit 21 calculates the intersection point A1 (X, Y) of the line SO and y=Ye, calculates the length of the line SA1, and may define the calculated length as the amount of movement. Furthermore, as illustrated in FIG. 27D, the correction value DB update unit 21 obtains a function passing the position E (Xe, Ye) of the tip of the cursor E and orthogonal to the line SO. Then, the correction value DB update unit 21 calculates the intersection point A2 (X, Y) of the obtained function and the line SO, calculates the length of the line SA 2, and may define the calculated length as the amount of movement.

The correction value DB update unit 21 accumulates the calculated amount of movement in, for example, the RAM 3 or the storage unit 4 for each area of the touched region. A specified number (for example, 20) of data sets of the amount of movement is accumulated for each area of the touched region, the correction value DB update unit 21 calculates the value to be updated for the correction value stored in the correction value DB 4a based on the accumulated data sets of amount of movement.

For example, the correction value DB update unit 21 reads the correction value stored in the correction value DB 4a corresponding to the area of the touched region of which the specified number of data sets of amount of movement is accumulated. That is, the correction value DB update unit 21 reads the correction value to be updated from the correction value DB 4a.

Then, the correction value DB update unit 21 removes an abnormal value from the amount of movement accumulated for each area of the touched region. For example, the correction value DB update unit 21 calculates the average of the accumulated amount of movement, and removes the amount of movement not within a specified range from the calculated average as an unusual value.

The correction value DB update unit 21 calculates the average of the amount of movement whose unusual value has been removed, and subtracts the calculated average from the correction value which is to be updated and has been read in advance from the correction value DB 4a. The acquired value is an average length of the line OA illustrated in FIG. 27B-27D, and is a correction value after the update. In the example illustrated in FIG. 27B, the length of the line OA is shorter than the length of the line SO. However, when the length of the line OA is longer than the line SO, the correction value DB update unit 21 adds the calculated average to the correction value to be updated and read in advance from the correction value DB 4a.

The correction value DB update unit 21 updates the correction value stored in the correction value DB 4a corresponding to the area of the touched region, for which the specified number of data sets of the amount of movement is accumulated, to the value calculated as a correction value after the update. Furthermore, the correction value DB update unit 21 deletes the data sets of the amount of movement accumulated in the RAM 3 or the storage unit 4 for calculating the updated correction value. Thus, the accumulation of an unnecessary data is suppressed, thereby efficiently utilizing the RAM 3 or the storage unit 4.

Each component other than the display mode determination unit 13, the touch finish detection unit 17, and the correction value DB update unit 21 according to the embodiment 7 performs the process similar to the embodiment 1.

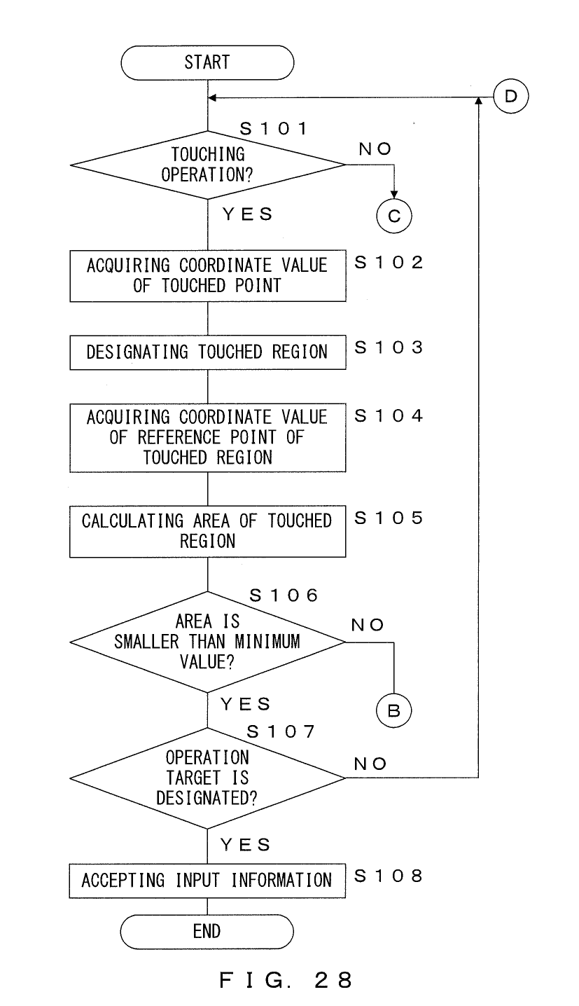

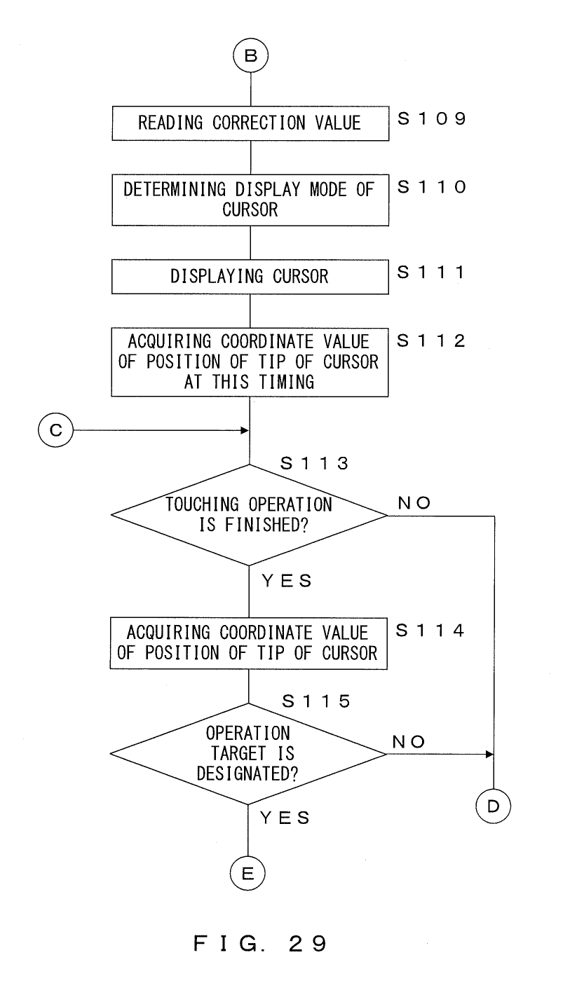

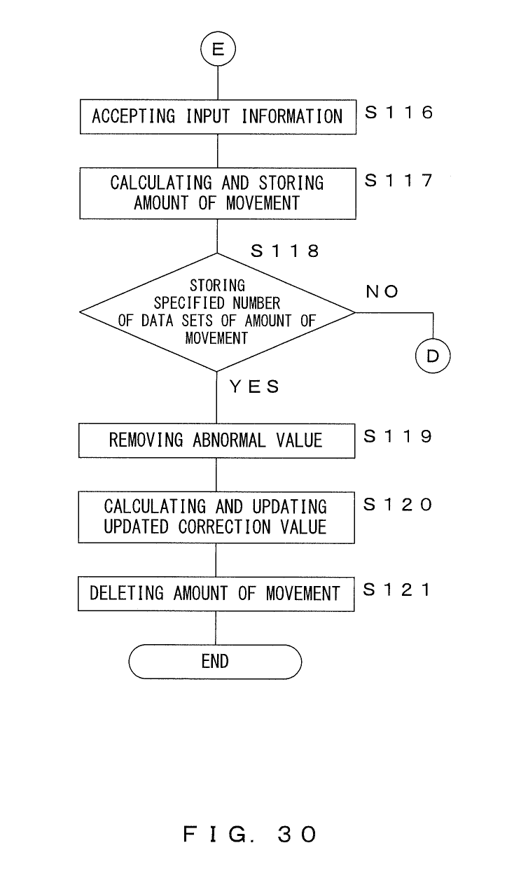

The process performed by the control unit 1 when a user performs the touching operation in the electric equipment 10 according to the embodiment 7 is described below with reference to a flowchart. FIG. 28 through FIG. 30 are flowcharts of the procedure of the input information accepting process according to the embodiment 7. The following process is performed by the control unit 1 according to the control program stored in the ROM 2 or the storage unit 4 of the electric equipment 10.

The control unit 1 detects whether or not a user performs the touching operation on the touch panel 6 according to the detection signal from the touch sensor 61 (S101). The control unit 1 transfers the control to step S113 when it does not detect the touching operation (NO in S101). When it detects the touching operation (YES in S101), it acquires the coordinate value of the touched point on which the user performs the touching operation (S102).

The control unit 1 designates the rectangular touched region R0 having the smallest size including all touched points based on the acquired coordinate value of the touched point (S103). The control unit 1 acquires the coordinate value of the reference point of the designated touched region R0 (5104). For example, the control unit 1 acquires the coordinate value of the center of the upper long side of the touched region R0. The control unit 1 also calculates the area of the designated touched region R0 (S105).

The control unit 1 determines whether or not the calculated area is smaller than the minimum value of the area of the touched region stored in the correction value DB 4a (S106). When it is determined that the calculated area is smaller than the minimum value (YES in S106), the control unit 1 tries to designate an operation target corresponding to the touched region R0 designated in step S103, and determines whether or not the corresponding operation target has been designated (S107). For example, the control unit 1 tries to designate an operation target including the touched region R0 in the display area of the operation target, and determines whether or not the operation target has been designated.

When the control unit 1 determines that no operation target has been designated (NO in S107), control is returned to step S101. When the control unit 1 determines that an operation target has been designated (YES in S107), the control unit 1 accepts the input information corresponding to the designated operation target (S108), and terminates the process.

When the control unit 1 determines that the area calculated in step S105 is equal to or exceeds the minimum value (NO in S106), it reads the correction value corresponding to the calculated area from the correction value DB 4a (S109). The control unit 1 determines the display mode of the cursor C to be described on the touch panel 6 based on the shape of the touched region R0 designated in step S103 and the correction value read from the correction value DE 4a (S110). For example, the control unit 1 calculates the coordinate value of the center of the upper long side of the touched region R0 and the coordinate value of the position at a distance of the correction value read from the correction value DB 4a in the direction perpendicular to the upper long side from the center of the upper long side of the touched region R0.

The control unit 1 outputs to the display unit 60 a display instruction for display of the cursor C in the display mode determined in step S110, and displays the cursor C on the display unit 60 (S111). The control unit 1 acquires the coordinate value of the position of the tip of the cursor S at this timing (when the touching operation is started) (S112).

The control unit 1 monitors according to the detection signal from the touch sensor 61 whether or not the user touching operation has been finished (S113). If the touching operation has not been finished (NO in S113), control is returned to step S101.

The control unit 1 repeats the processes in steps S101 through S112 until it is detected that the touching operation has been finished. When it is detected that the touching operation has been finished (YES in S113), the control unit 1 acquires the coordinate value of the position of the tip of the cursor E displayed at this timing (when the touching operation is finished) (S114). The control unit 1 tries to designate an operation target corresponding to the acquired position of the tip of the cursor E, and determines whether or not the corresponding operation target has been designated (S115). For example, the control unit 1 tries to designate an operation target including the position of the tip of the cursor E in the display area of the operation target, and determines whether or not the operation target has been designated.

The control unit 1 returns control to step S101 when it is determined that the operation target cannot be designated (NO in S115). When it is determined that the operation target can be determined (YES in S115), the control unit 1 accepts the input information corresponding to the designated operation target (S116).

The control unit 1 calculates the amount of movement from the cursor S to the cursor E based on the coordinate value of the reference point of the touched region R0 acquired in step S104, the coordinate value of the position of the tip of the cursor acquired in step S112, and the coordinate value of the position of the tip of the cursor E acquired in step S114. The control unit 1 stores the calculated amount of movement associated with the area of the touched region R0 in the RAM 3 or the storage unit 4 (S117). The control unit 1 determines whether or not a specified number of data sets of the amount of movement is stored for the area corresponding to the newly stored amount of movement (S118).

When it is determined that the specified number of data sets of the amount of movement is not stored (NO in S118), the control unit 1 returns control to step S101. When the control unit 1 determines that the specified number of data sets of the amount of movement is stored (YES in S118), the control unit 1 removes an unusual value from the stored amount of movement (S119). The control unit 1 calculates the correction value after the update to the correction value stored in the correction value DB 4a based on the amount of movement from which the abnormal value has been removed, and updates the correction value stored in the correction value DB 4a to the calculated correction value after the update (S120).

For example, the control unit 1 calculates an average of the amount of movement from which the unusual value has been removed, and calculates the correction value after the update based on the calculated average and the correction value stored in the correction value DB 4a at this timing.

The control unit 1 deletes the amount of movement stored in the RAM 3 or the storage unit 4 to calculate the correction value after the update in step S120 (S121), thereby terminating the process.

As described above, in the embodiment 7, the correction value stored in the correction value DB 4a is dynamically updated based on the amount of movement of the cursor from the starting point of the touching operation to the ending point of the touching operation. Therefore, since the correction value depending on the amount of movement for the user actually moving the cursor is set in the correction value DB 4a, the correction value appropriate for the user can be set. Therefore, the position of the cursor displayed when the user starts the touching operation can be optimized depending on the use state of the user, thereby improving the operability because the movement distance of the cursor by the user performing the touching operation is reduced.

The embodiment 7 is described above as a variation example of the embodiment 1, but can also be applied to the configuration of the embodiments 2 through 6.

### Embodiment 8

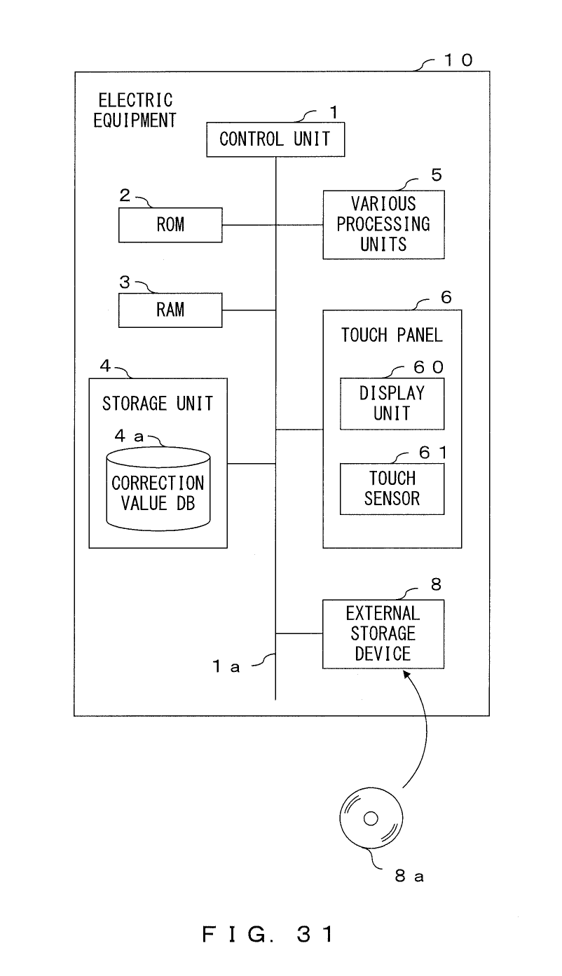

Described below is the electric equipment according to the embodiment 8. FIG. 31 is a block diagram of an example of the configuration of the electric equipment 10 according to the embodiment 8. The electric equipment 10 according to the embodiment 8 includes an external storage device 8 in addition to the hardware components illustrated in FIG. 1. The external storage device 8 is, for example, a CD-ROM drive, a DVD drive, etc., and reads data stored in a record medium 8a such as CD-ROM, DVD-ROM, etc.

The record medium 8a records a control program necessary for operation as the electric equipment 10 described in the embodiments above. The external storage device 8 reads the control program from the record medium 8a, and stores the program in the storage unit 4. The control unit 1 reads the control program stored in the storage unit 4 to the RAM 3, and executes the program, thereby allowing the electric equipment 10 according to the embodiment 8 to perform operations of the electric equipment 10 as described with reference to the embodiments.

The control program for detecting the touching operation on the touch panel 6 by the user and displaying the cursor etc. on the electric equipment 10 according to the embodiments above is, for example, UI middleware as the middleware for a user interface. The control program may be included in OS software, and when the control program is included in OS software, it is stored in the record medium 8a as OS software. Furthermore, the control program may also be included in application software, and when the control program is included in application software, it is stored in the record medium 8a as application software.

The record medium 8a may be various types of record media such as a flexible disk, a memory card, a USB (universal serial bus) memory, etc. in addition to the CD-ROM or DVD-ROM.

The electric equipment 10 may include a communication unit for connection to a network such as the Internet or a LAN (local area network), etc. In this case, the electric equipment 10 may download a necessary control program for operating as the electric equipment 10 described above in the embodiments through a network, and store the program in the storage unit 4.

In the above-mentioned embodiments, the electric equipment 10 includes the touch panel 6, and the control unit 1 of the electric equipment 10 detects the touching operation on the touch panel 6 by the user and displays a cursor, etc. However, for example, when the cursor display correcting function performed by a server is used in the terminal device provided with the touch panel 6, the present application can be applied to the terminal device. In this case, the terminal device detects the touching operation on the touch panel 6 by the user, and the server instructs the terminal device to display the cursor.

For example, the terminal device detects the touching operation on the touch panel 6 by the user, and transmits a detection result to the server. Then, the server determines the display mode of the cursor based on the detection result acquired from the terminal device, and transmits the determined display mode to the terminal device. The terminal device displays the cursor on the touch panel 6 of the terminal device according to the display mode received from the server. Thus, also in the terminal device used when a server is used over a network, similar effect as the electric equipment 10 according to the embodiments can be acquired.

In the above described embodiments, the touch sensor 61 of the touch panel 6 detects the touched point with the touch panel 6 when the user performs the touching operation. However, the pen dedicated for the operation of the touch panel 6 may acquire the touched point with the touch panel 6 and the information about the touched region. For example, a sensor for detecting a specified pattern on the touch panel 6 or a recording sheet and detecting where on the touch panel 6 or the recording sheet the tip of the pen touches may be provided. When such a pen touches the touch panel 6 or the recording sheet on which the specified pattern is formed, the information about the touched point detected by the pen is acquired by the electric equipment 10, the similar processes performed by the electric equipment 10 according to the embodiments above can be performed.

In the embodiments above, when the area of the touched region by the user is smaller than the minimum value of the area of the touched region stored in the correction value DB 4a, the cursor is not displayed, and the operation target including the touched region in the display area of the operation target is selected. In addition to this configuration, the operation target including the touched region in the display area of the operation target may be selected without displaying the cursor when the time period during the user performs the touching operation is measured and the measured time period is smaller than a specified time (for example, one second). That is, when the time period during the user performs the touching operation is equal to or exceeds the specified time (for example, one second), the display of the cursor in the position depending on the area of the touched region may be started.

In the embodiments above, the cursor is displayed in the position depending on the area of the touched region when the user performs the touching operation. In addition to the configuration when, for example, a user performs the touching operation with his or her finger, a sensor implemented in the electric equipment 10 may detect the length from the touched region to the tip of another finger. In this case, by displaying the cursor in the position at a distance of at least the detected length from the touched region, the cursor can be prevented from being displayed in the position in which the cursor is hidden by the other finger.

In the embodiments above, the distance from the touched region to the tip of the cursor is determined depending on the area of the touched region when the user performs the touching operation, but the length of the cursor having the touched region as a starting point maybe determined depending on the area of the touched region. In this case, the column of the correction value of the correction value DB 4a stores not the distance from the touched region to the tip of the cursor, but the length of the cursor having the touched region as a starting point in association with the area of the touched region. The cursor is made to be sufficiently long depending on the area of the touched region as with the correction value using the minimum length as a reference with the area hidden by the fingers surrounding the touched region taken into account. With the configuration, similar effect achieved by the embodiments above can be obtained.

As described above, according to the present application, an operation target indicator is displayed in the display mode depending on the touched region by a touching operation of a user. Thus, the operation target indicator is displayed in an appropriate mode regardless of the influence of the use state of the equipment and the touching state of the user. Therefore, the operation target corresponding to a touched region in the user touching operation can be finished with accuracy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has (have) been described in detail, it should be understood that the various changes, substitutions, and alterations could be made hereto without departing from the spirit and scope of the invention.

What is claimed is:

1. A non-transitory computer readable medium for storing a computer program which enables a computer to perform an input method for accepting input information by a touching operation on a touch target, the input method comprising:
acquiring information about the touched region in which the touching operation is performed on the touch target;
determining a display mode of an operation target indicator displayed with the touching operation according to the information about the touched region;
outputting a display instruction for displaying the operation target indicator in the determined display mode;
moving the displayed operation target indicator according to the movement of the touched region; and
accepting the input information corresponding to a display position of the operation target indicator when the touching operation is finished.

2. The non-transitory computer readable medium according to claim 1, wherein
the information about the touched region is a area.

3. The non-transitory computer readable medium according to claim 1, wherein
the display mode indicates a size of the operation target indicator.

4. The non-transitory computer readable medium according to claim 1, wherein
the display mode indicates a distance from an edge of the touched region to a tip of the operation target indicator.

5. The non-transitory computer readable medium according to claim 1, wherein
the information about the touched region indicates an area of the touched region and a rectangle corresponding to the touched region,
the determining determines a position on the rectangle as a starting point of the operation target indicator depending on the area of the touched region.

6. The non-transitory computer readable medium according to claim 1, wherein
the determining suppresses a display of the operation target indicator when the area of the touched region is equal to or lower than a threshold,
the accepting accepts input information corresponding to the touched region at a timing when the touching operation finishes.

7. The non-transitory computer readable medium according to claim 6, the input method further comprising
setting the threshold depending on a size of an operation target specified by the operation target indicator.

8. The non-transitory computer readable medium according to claim 1, the input method further comprising
acquiring information about an operation state of an equipment including the touch target, wherein
the determining determines the display mode of the operation target indicator according to the information about the operation state of the equipment and the information about the touched region.

9. The non-transitory computer readable medium according to claim 8, wherein
the information about the operation state is obtained based on a detection signal output from a detection circuit for detecting the operation state of the equipment.

10. The non-transitory computer readable medium according to claim 9, wherein
the detection circuit detects a touching pressure by a touching operation on the touch target.

11. The non-transitory computer readable medium according to claim 9, wherein
the detection circuit detects an inclination of the equipment.

12. The non-transitory computer readable medium according to claim 1, the input method further comprising
classifying the touched region into a plurality of touched region clusters according to the information about the touched region; wherein
one touched region cluster is selected depending on each area of the plurality of touched region clusters,
the determining determines the display mode of the operation target indicator according to the information about the selected touched region cluster.

13. The non-transitory computer readable medium according to claim 1, the input method further comprising:
detecting a finishing position of the touching operation on the touch target;
designating information for determination of the display mode of the operation target indicator based on the information about the touched region, the determined display mode, and the detected finishing position, wherein
the determining determines the display mode of the operation target indicator according to the designated information and the information about the touched region.

14. An input device which accepts input information by a touching operation performed on a touch target, comprising:
a display unit;
a touch sensor;
a storage unit;
a touched region acquisition unit to acquire information about the touched region in which the touching operation is performed on the touch target using the touch sensor;
a determination unit to determine a display mode of an operation target indicator displayed with the touching operation by referring to information stored in the storage unit according to the information about the touched region acquired by the touched region acquisition unit;
an output unit to output a display instruction for displaying the operation target indicator on the display unit in the display mode determined by the determination unit;
a designation unit to designate an operation target based on a display position of the operation target indicator when the touching operation is finished;
a notification unit to notify the designated operation target of the input information by the touching operation;
a movement unit to move the displayed operation target indicator according to the movement of the touched region; and
an acceptance unit to accept the input information corresponding to the display position of the operation target indicator when the touching operation is finished.

15. The input device according to claim 14, further comprising
a touch detection unit to detect a portion on which the touching operation is performed on the touch target, wherein
the touched region acquisition unit acquires the information about the touched region based on the portion detected by the touch detection device.

16. An input method for accepting input information by a touching operation performed on a touch target, comprising:
acquiring information about the touched region in which the touching operation is performed on the touch target;
determining a display mode of an operation target indicator displayed with the touching operation according to the information about the touched region;
outputting a display instruction for displaying the operation target indicator in the determined display mode;
moving the displayed operation target indicator according to the movement of the touched region; and
accepting the input information corresponding to a display position of the operation target indicator when the touching operation is finished.
